(19) United States
(12) Patent Application Publication
(10) Pub. No.: US 2019/0228679 A1
(43) Pub. Date: Jul. 25, 2019

(54) SYSTEM AND METHOD FOR PROVIDING MATHEMATICS EDUCATION INSTRUCTIONS

(71) Applicant: Michael Perry Dowell, Pasadena, CA (US)

(72) Inventor: Michael Perry Dowell, Pasadena, CA (US)

(21) Appl. No.: 15/876,135

(22) Filed: Jan. 20, 2018

(51) Int. Cl. G09B 19/02; G09B 7/06; G09B 7/08; A63F 13/2145; A63F 13/85

(52) U.S. Cl. CPC G09B 19/025; G09B 7/066; A63F 2300/8064; A63F 13/2145; A63F 13/85; G09B 7/08

(57) ABSTRACT

A method and program product includes selecting by a user, a game using a designated software program loaded in a computer system. The user may select a a difficulty level of the game for playing and a game category within the selected difficulty level of the game for playing using the designated software program in the computer system. The method and program product include transmitting game instruction, wherein the game instruction comprises number words that contain place value for any number that ends in 11-99 and/or contains a period value ending in 11-99. The user input is checked by the designated software program to determine if the user input is correct. If the user input is incorrect a fail message is transmitted and displayed. If the user input is correct a reward message is transmitted and displayed. The user is then allowed to proceed to a new question in the game.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a computer implemented method for providing mathematics education instructions. More particularly, certain embodiments of the invention relate to a computer implemented method for providing mathematics education instructions in the area of “number sense” (the relative value of numbers) using number words that contain place value for any number that ends in 11-99 and/or contains any period value ending in 11-99.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Teaching number sense and place value to mathematics learners may pose a significant challenge, particularly a problem created by our current number words, as the number words we typically use today may be very confusing for mathematics learners, particularly children from Kindergarten to Grade 3 who may be spending countless hours of study learning number sense. For example, the number words “thirteen” and “thirty” are many a time easily confused and this may pose a significant problem to mathematics learners. The confusion may typically arise because the tens place is switched in order of pronunciation. i.e., when the word “thirteen” is spoken, the tens place comes last, while in the word “thirty” the tens place comes first. The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is methods featuring a physical board, many identical items, and a computer software to perform traditional mathematical operations, methods featuring models which may help guide a student form visual concepts to mathematical procedures, graphical user interfaces used in a learning system for a user to interact with the learning system using the selectable elements of multiple levels used for navigation in choosing a knowledge point to be studied, etc. . . . .

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a flowchart of an exemplary method for providing a number sense to a user, in accordance with an embodiment of the present invention;

FIG. 2 illustrates a listing of number words for use in an exemplary method for providing a number sense to a user, in accordance with an embodiment of the present invention;

FIG. 3 illustrates a listing of number words for use in an exemplary method for providing a number sense to a user, in accordance with an embodiment of the present invention;

FIG. 4 illustrates an interface for mathematical operations for use in an exemplary method for providing a number sense to a user, in accordance with an embodiment of the present invention;

FIG. 5 illustrates an interface for mathematical operations for use in an exemplary method for providing a number sense to a user, in accordance with an embodiment of the present invention;

FIG. 6 illustrates an interface for mathematical operations for use in an exemplary method for providing a number sense to a user, in accordance with an embodiment of the present invention;

FIG. 7 illustrates an interface for mathematical operations for use in an exemplary method for providing a number sense to a user, in accordance with an embodiment of the present invention;

FIG. 8 illustrates an interface for mathematical operations for use in an exemplary method for providing a number sense to a user, in accordance with an embodiment of the present invention;

FIG. 9 illustrates an interface for mathematical operations for use in an exemplary method for providing a number sense to a user, in accordance with an embodiment of the present invention;

FIG. 10 illustrates an interface for mathematical operations for use in an exemplary method for providing a number sense to a user, in accordance with an embodiment of the present invention;

FIG. 11 illustrates an interface for mathematical operations for use in an exemplary method for providing a number sense to a user, in accordance with an embodiment of the present invention;

FIG. 12 illustrates an interface for mathematical operations for use in an exemplary method for providing a number sense to a user, in accordance with an embodiment of the present invention;

FIG. 13 illustrates an interface for mathematical operations for use in an exemplary method for providing a number sense to a user, in accordance with an embodiment of the present invention;

FIG. 14 illustrates an interface for mathematical operations for use in an exemplary method for providing a number sense to a user, in accordance with an embodiment of the present invention;

FIG. 15 illustrates an interface for mathematical operations for use in an exemplary method for providing a number sense to a user, in accordance with an embodiment of the present invention;

FIG. 16 illustrates an interface for mathematical operations for use in an exemplary method for providing a number sense to a user, in accordance with an embodiment of the present invention;

FIG. 17 illustrates an interface for mathematical operations for use in an exemplary method for providing a number sense to a user, in accordance with an embodiment of the present invention;

FIG. 18 illustrates an interface for mathematical operations for use in an exemplary method for providing a number sense to a user, in accordance with an embodiment of the present invention;

FIG. 19 illustrates an interface for mathematical operations for use in an exemplary method for providing a number sense to a user, in accordance with an embodiment of the present invention;

FIG. 20 illustrates an interface for mathematical operations for use in an exemplary method for providing a number sense to a user, in accordance with an embodiment of the present invention;

FIG. 21 illustrates an interface for mathematical operations for use in an exemplary method for providing a number sense to a user, in accordance with an embodiment of the present invention;

FIG. 22 illustrates an interface for mathematical operations for use in an exemplary method for providing a number sense to a user, in accordance with an embodiment of the present invention;

FIG. 23 illustrates an exemplary system for providing a number sense to a user, in accordance with an embodiment of the present invention;

FIG. 24 illustrates an architecture of an exemplary computing system for providing a number sense to a user, in accordance with an embodiment of the present invention;

FIG. 25 illustrates a block diagram depicting a conventional client/server communication system, which may be used by an exemplary web-enabled/networked embodiment of the present invention; and

FIG. 26 is a block diagram depicting an exemplary client/server system which may be used by an exemplary web-enabled/networked embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of” and “consisting essentially of” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Embodiments of the invention disclosed herein may provide a computer-implemented method for providing math education instructions, i.e., number sense and place value, via an interactive game software comprising an on-screen display of a regular system of number words that may contain place value in the tens and ones position for any number, to fix the problem with numbers that end in 11-99 and/or contain one or more period values ending in 11-99, for example, currently the number word for 11 does not contain place value. So instead of saying “eleven” a user may say “ten one”, as 11 equals ten plus one, which may result in the creation of a regular system of number words in the English language known as “Ten One” number words that may be utilized in various game types, such as operations, counting, greater than less than or equal to, true/false, sentence and matching, and the like. Typically, in spoken and in written Ten One number words, any number that ends in 11-99 and/or contains one or more period values ending in 11-99 may be improved by expressing accurate place value. The term “period value” means for numbers over 999, the digits are grouped into sets of three and separated by commas, spaces, or periods. For example, in the number 123,456,789 there are 3 period values: 789 is the first period and is expressed using Ten One number words as seven hundred eight ten nine units; 456 is the second period and is expressed using Ten One number words as four hundred five ten six thousands; and 123 is the third period and is expressed using Ten One number words as one hundred two ten three millions.

More particularly, in an exemplary embodiment, math learning beginners, may learn number sense susbtantially more easily through math instructions that may feature number words that contain place value, as illustrated and demonstrated with reference to a variety of game categories hereinbelow. Accordingly, embodiments of the invention disclosed herein, may provide a replacement for substantially difficult number words that may not contain a place value, for example, eleven, twelve, thirteen, etc. with a regular system of number words that may contain place value, for example, ten one, ten two, ten three, etc. In one embodiment, the invention disclosed herein may assist in eliminating the early difficulties faced by math learners and teachers as the method disclosed herein may be logical, simple and easy to master. In one embodiment, the invention disclosed herein may have an added advantage of unifying all number words into a regular system/pattern of number words, which may promote learning as it may be more intuitive than the number words used in math education today. Accordingly, in one embodiment, the invention disclosed herein may haven an additional advantage of being in alignment with all other number words outside of the range of numbers that end in 11-99 and/or contain period values ending in 11-99, to form a complete unified system of counting which may accurately and immediately convey place value and help to teach and convey number sense to all math learners.

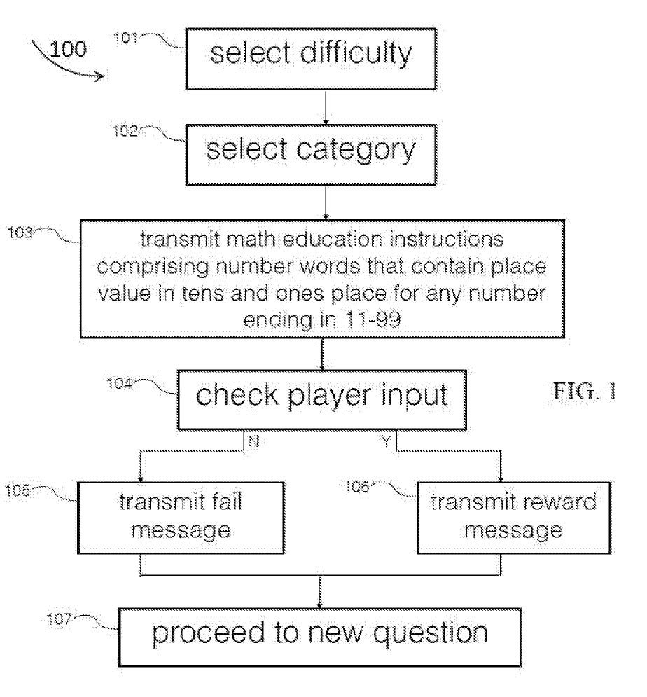

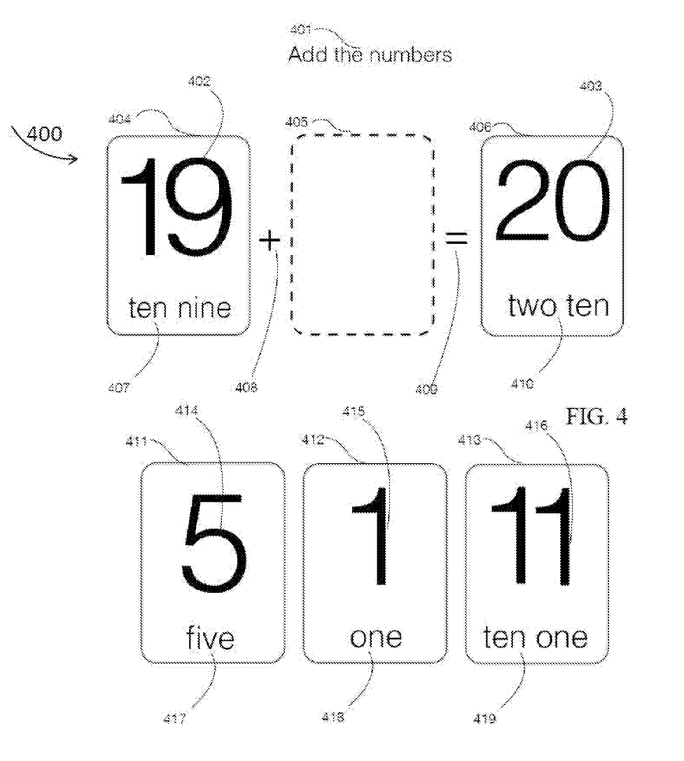

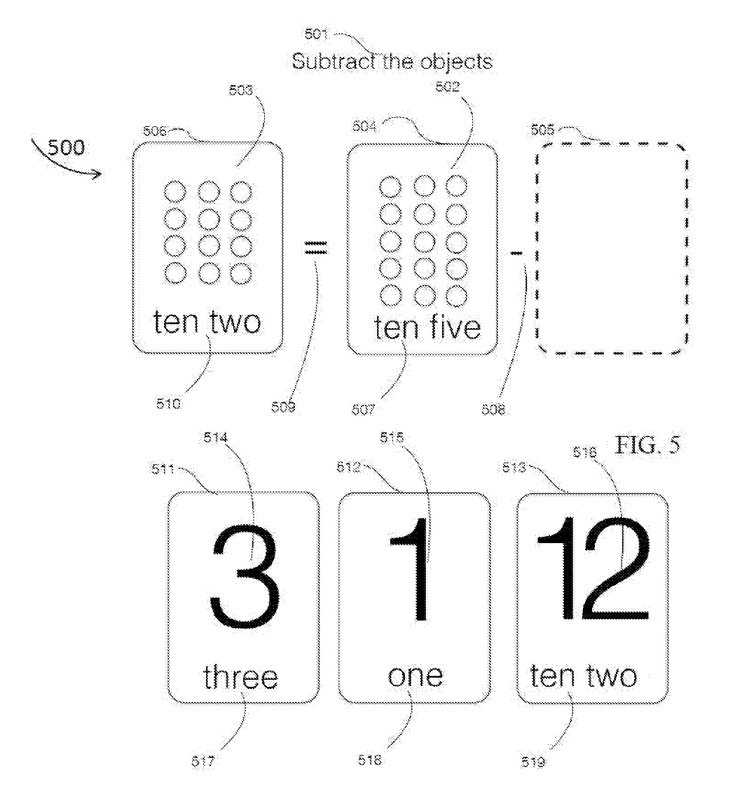

Referring to FIG. 1 is illustrated a flowchart of an exemplary method for providing a number sense to a user, in accordance with an embodiment of the present invention. In a step 101 a user may select a difficulty of a game level for play using a designated software program loaded in a computer system. For example, the difficulty of a game level may include numbers ranged 11-20, or numbers ranged 1-20 as illustrated in FIG. 4, or numbers ranged 1-15 as illustrated in FIG. 5. In a step 102 the user may then select a category within the difficulty level selected in step 101 of a game level for play using the designated software program loaded in the computer system as described herein below with reference to FIG. 4-22. In a step 103, math education instructions may be transmitted which may comprise Ten One number words, for example, number words that contain place value for any number that ends in 11-99 and/or contains a period value ending in 11-99. In one embodiment, the games may include various categories, but not be limited to, operator games, matching games, algebraic games, visual object games, dragging games, grouping games, and the like. Suitable examples of game categories from which the user may choose from within selected difficulty level of a selected game may include, but may not be limited to:

(a) Operations (add, subtract, multiply, divide): Operations questions/game instructions may require a minimum of 3 value fields displaying numerals and equivalent number words in the ten one format described herein, an operator like add (+) subtract (−) multiply (×) or divide (÷) and an equals sign (=). One of the 3 value fields or the operator may be unknown. For example, 10 “ten”+10 “ten”=? where the answer is 20, i.e., “two ten”.

(b) Sentence (add, subtract, multiply, divide): Sentence questions may require a minimum of 1 written statement that may use descriptive words to convey a math problem. For example, “Billy has 5 oranges, he gets 10 more from Peter. How many oranges does Billy have?” In one embodiment, in the present invention, either a question/written statement or an answer may contain ten one number words. In the current example, the player may get a correct answer by selecting 15 “ten five”.

(c) Counting: Counting questions may require a count number displayed as number words in Ten One format and a minimum of 1 object to be counted. In some embodiments, the count number may be displayed with or without a corresponding numeral. A starting number can be any integer, for example 0. A count increment may typically be an integer, for example, 1, but it could also be a decimal number such as 1.001. When player selects a counting object, the count number may “count” by count increment—for example if the starting number is 0 and the count increment is 1, when player taps the first count object, the count number will increase from 0 to 1. Game may be over when value of the count number may reach a specified target number, or when player has tapped all count objects. For example, (1) “Count by is (ones)” and player must tap 11 objects to count up to 11 “ten one”; (2) “Starting from 20, count by 2s (twos)” and player must tap 5 objects to count up to 30 “three ten”; and (3) “Starting from 60, count up to 80” and player must tap objects to count by 1s (ones) from 60 “six ten” to 80 “eight ten”.

(d) Greater Than, Less Than, or Equal to (GLE): GLE questions may require a minimum of 2 value fields displaying numerals and equivalent number words in Ten One format, and an unknown sign which can be selected from: less than “<”, greater than “>” or equal to “=”. A player may choose the correct answer among signs, for example less than “<”, greater than “>” or equal to “=”. For example, 25 “two ten five”? 20 “two ten”. Player may get a correct answer by selecting greater than “>” since 25 “two ten five” is greater than 20 “two ten”.

(e) Matching: Matching questions require a minimum of 4 matching objects. Player may match numerals to their equivalent ten one number words. For example, if the objects are “20”, “13”, “ten three” and “two ten”, player must match “20” to “two ten” and “13” to “ten three”.

(f) True or False: True or False questions require a minimum of 1 statement or equation, displaying number words in Ten One format. Player may choose the correct answer among answer buttons that may register “True” or “False”. For example, “Ten one is greater than ten two. True or false?”. Player will get a correct answer by selecting “False”, since 11 “ten one” is not greater than 12 “ten two”.

In step 104 the designated software program in the computer system may check player input to determine if the answer provided by the player is correct “Y” or incorrect “N”. If incorrect in step 105, a fail message may be transmitted. If correct in step 106, a reward message may be transmitted. The player may then proceed to a new question in a step 106.

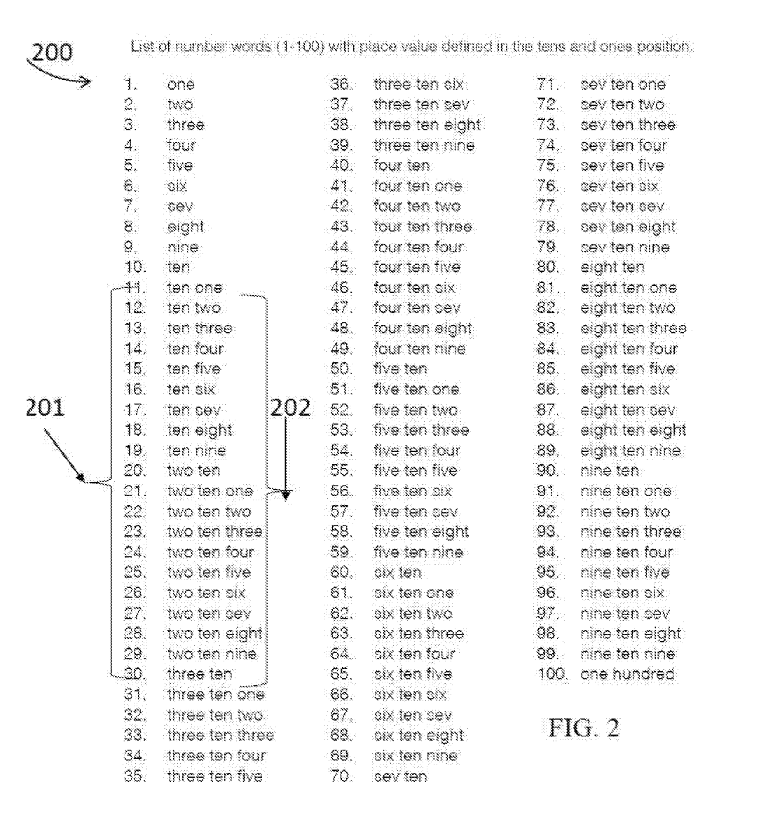

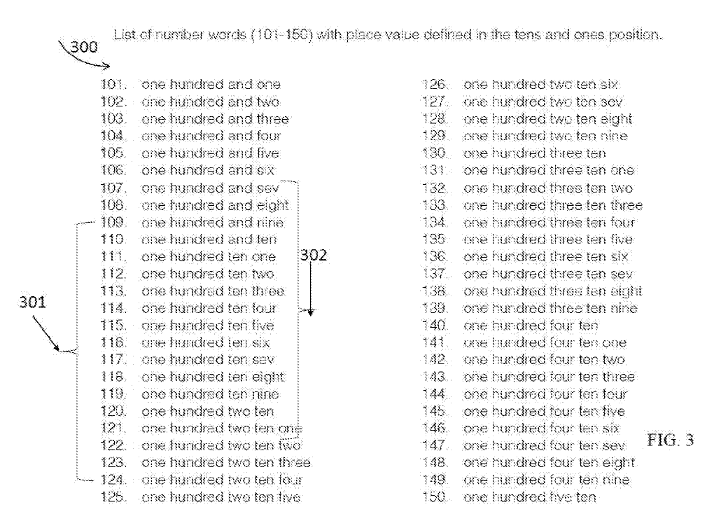

Referring to FIG. 2 and FIG. 3, is illustrated a listing of number words 200, 300 respectively for use in an exemplary method for providing a number sense to a user, in accordance with an embodiment of the present invention. Accordingly, FIG. 2 includes a list of number words 1-100 which contain accurate place value for any number that ends in 11-99 and/or contains a period value ending in 11-99 and FIG. 3 includes a list of number words 101-150 which contain accurate place value for any number that ends in 11-99 and/or contains a period value ending in 11-99. Common numerals 201, 301 are listed with corresponding number words 202, 302 used in the designated software program. It may be appreciated by a person with ordinary skill in the art, in light of and in accordance with the teachings of the present invention, that the number words in this list contain definition of place value in tens and ones position which is unlike number words currently used in math education in any other software program or product. In one embodiment, is provided a formula for number words with place value defined in the tens and ones position. In any number, replace number word(s) transmitted in tens and ones place like 31 “thirty one” with number words that accurately describe number of tens and ones like 31 “three ten one”. For example, 151 may be transmitted as “one hundred five ten one” and 987,654,321 may be transmitted as “nine hundred eight ten sev(en) million, six hundred five ten four thousand, three hundred two ten one”. It may be appreciated by a person with ordinary skill in the art, in light of and in accordance with the teachings of the present invention, that a list of Ten One number words 1-150 is included in FIG. 2 and FIG. 3 for demonstration. It may not be possible to compile an exhaustive list because the list may be infinite, as the Ten One number words formula can be applied to any number that ends in 11-99 and/or contains a period value that ends in 11-99.

Referring to FIG. 4, is illustrated an interface 400 for mathematical operations for use in an exemplary method for providing a number sense to a user, in accordance with an embodiment of the present invention. Accordingly, FIG. 4 provides an interface drawing representative of the “Operations” category of games described herein above. In this game, math instructions may display operations questions like add, subtract, multiply, and divide. On display may be random groups of objects on a field (similar to a card), so each question may not always be the same on replay. Numerals may be selected within a range that corresponds with user's selected difficulty level. As described with reference to FIG. 1, the user must tap the correct answer from multiple choice answers at the bottom of the screen. In an embodiment, when a correct answer is tapped, the correct answer may move to the blank position in the question above, and a reward message may be displayed. In an embodiment, when an incorrect answer is tapped, the user may get a fail message and may have the ability to retry until user taps the correct answer. Once the user is able to obtain the correct answer for a question, the user may then proceed to the next question. In another embodiment, (not shown in figure) the user may proceed with the next question even if the user taps a correct answer. In one embodiment, when the user taps an incorrect answer the software may display instructions on how to get the correct answer, and user may get points according to correct answers, and/or software could display percentage of correct answers. with the next question even if the user taps a correct answer. In another embodiment, when the user taps an incorrect answer the software may allow the user to move on to the next question, and user may get points according to correct answers, and/or software could display percentage of correct answers. In one embodiment, the software may provide the user with a link at the end, after displaying the points for the correct answers, to enable the user to understand the error committed and learn the method of steps to get to the correct answers. In an exemplary embodiment, illustrated in FIG. 4, instructions for a game may be written at the top of a screen, i.e., “add the numbers” 401. A question field, may include a random numeral “19” 402 is displayed on field 404, which corresponds to number words “ten nine” 407 on field 404, a random numeral “20” 403 is displayed on field 406, which corresponds to number words “two ten” 410 on field 403, a dashed line or “blank” field 405. In various embodiments, the fields 404, 405, 406 may include, but not be limited to a white, colored, textured, etc. . . . background field upon which numbers, objects or number words are displayed. In one embodiment, when a user taps any one of the field 411, 412, 413 in the answer field that may display the correct answer, the correct answer field may move and occupy the position in the blank field 405. Correct answer will appear on top of the blank, so that the blank will no longer be visible and the correct answer will be visible instead. In one embodiment, the number words 407, 410 may correspond to numeral 402, 403 respectively on field 404, 406 respectively. The number words contain accurate place value for any number that ends in 11-99 and/or contains a period value that ends in 11-99. An operator position 408 in FIG. 4 includes the add (+) operator sign. In an actual game, other operators may appear here such as subtract (−), multiply (×) or divide (÷). An operator position 409 in FIG. 4 includes the equal to (=) operator sign. In an actual game, other operators may appear here such as subtract (−), multiply (×) or divide (÷). In certain embodiments, the operator position 409 in FIG. 4 showing the equal sign (=) may be switched with the other operator position 408, i.e., the equals sign (=) may appear in this position 408 and the operator for add, subtract, multiply or divide may appear in the position 409. In various embodiments, the fields 411, 412, 413, any one of which may include the correct answer, that when selected completes the requirement of number requirement of field 405, may include, but not be limited to a white, colored, textured, etc. . . . background field upon which numbers, objects, or number words are displayed, similar to fields 404, 405, and 406. An answer field may include a random numeral, for example, “5” 414 in field 411, “1” 415 in field 412, and “11” 416 in field 413, which may correspond to number words on answer field. The answer field may also include number words that may correspond to the random numerals, for example, “five” 417 in field 411 corresponding to “5” 414, “one” 418 in field 412 corresponding to “1” 415, and “ten one” 419 in field 413 corresponding to “11” 416. The number words contain place value for any number that ends in 11-99 and/or contains a period value that ends in 11-99, in accordance with embodiments of the present invention.

Referring to FIG. 5, is illustrated an interface 500 for mathematical operations for use in an exemplary method for providing a number sense to a user, in accordance with an embodiment of the present invention. Accordingly, FIG. 5 provides an interface drawing representative of the “Operations” category of games described herein above. In this game, math instructions may display operations questions like add, subtract, multiply, and divide. On display may be groups of objects on a field, in random quantity, so each question will not always be the same on replay. Below the group of objects are number words that correspond with the number of objects and the number words utilize format provided in FIG. 2 and FIG. 3. Quantity of objects displayed may be selected at random within a range that corresponds with user's selected difficulty level. As described with reference to FIG. 1, the user must tap the correct answer from multiple choice answers at the bottom of the screen. In an embodiment, when a correct answer is tapped, the correct answer may move to the blank position in the question above, and a reward message may be displayed. In an embodiment, when an incorrect answer is tapped, the user may get a fail message and may have the ability to retry until user taps the correct answer. Once the user is able to obtain the correct answer for a question, the user may then proceed to the next question. In an exemplary embodiment, illustrated in FIG. 5, instructions for a game may be written at the top of a screen, i.e., “subtract the objects” 501. A question field, may include a random number of objects 503 displayed on field 506, which may correspond to number words “ten two” 510 on field 506, a random number of objects 502 is displayed on field 504, which may correspond to number words “ten five” 507 on field 504, a dashed line or “blank” field 505. In various embodiments, the fields 506, 504, 505 may include, but not be limited to a white, colored, textured, etc. . . . background field upon which numbers, objects or number words are displayed. In one embodiment, when a user taps any one of the field 511, 512, 513 in the answer field that may display the correct answer, the correct answer field may move and occupy the position in the blank field 505. Correct answer will appear on top of the blank, so that the blank will no longer be visible and the correct answer will be visible instead. In one embodiment, the number words 507, 510 may correspond to objects 502, 503 respectively on field 504, 506 respectively. The number words contain accurate place value for any number that ends in 11-99 and/or contains a period value that ends in 11-99. An operator position 508 in FIG. 5 includes the subtract (−) operator sign. In an actual game, other operators may appear here such as add (+) multiply (×) or divide (÷). An operator position 509 in FIG. 5 includes the equal to (=) operator sign. In an actual game, other operators may appear here such as add (+), multiply (×) or divide (÷). In certain embodiments, the operator position 509 in FIG. 5 showing the equal sign (=) may be switched with the other operator position 508, i.e., the equals sign (=) may appear in the position 508 and the operator for add, subtract, multiply or divide may appear in the position 509. In various embodiments, the fields 511, 512, 513, any one of which may include the correct answer, that when selected completes the requirement of number requirement of field 505, may include, but not be limited to a white, colored, textured, etc. . . . background field upon which numbers, objects, or number words are displayed, similar to fields 504, 505, and 506. An answer field may include a random numeral, for example, “3” 514 in field 511, “1” 515 in field 512, and “12” 516 in field 513, which may correspond to number words on answer field. The answer field may also include number words that may correspond to the random numerals, for example, “three” 517 in field 511 corresponding to “3” 514, “one” 518 in field 512 corresponding to “1” 515, and “ten two” 519 in field 513 corresponding to “12” 516. The number words contain place value for any number that ends in 11-99 and/or contains a period value that ends in 11-99, in accordance with embodiments of the present invention.

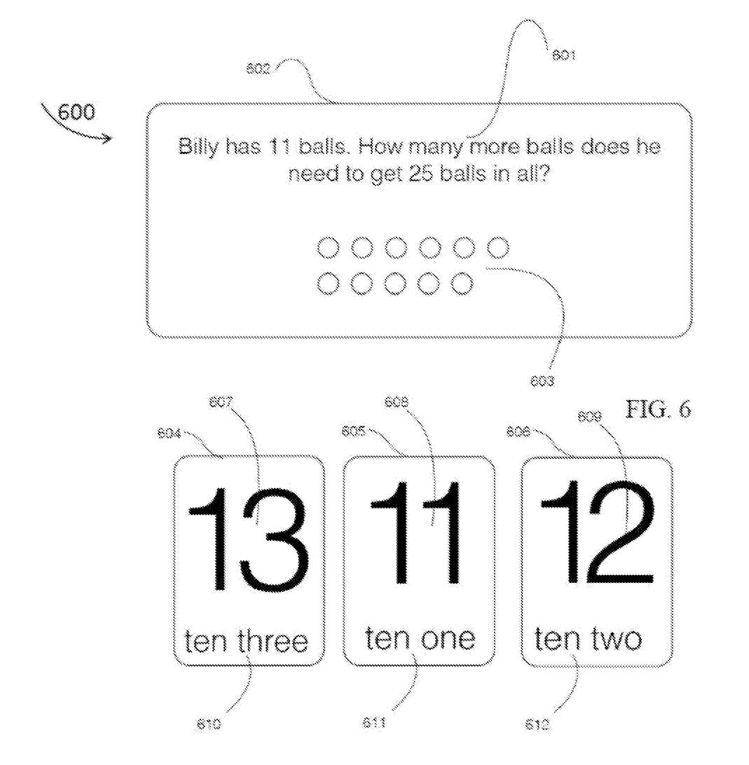

Referring to FIG. 6, is illustrated an interface 600 for mathematical operations for use in an exemplary method for providing a number sense to a user, in accordance with an embodiment of the present invention. Accordingly, FIG. 6 provides an interface drawing representative of the “Sentence” category of games described herein above. In this game, math instructions be described in detail with a focus on storytelling and the written word. The question area (shown at the top of screen in this figure) will also display a representational image/symbols of a number of objects. In the answer area, users can select from multiple answers. In this figure, answers feature “Ten One” number words which utilize format provided in FIG. 2 and FIG. 3. Accordingly, in a top half of the screen/page a descriptive instruction in sentence format 601 may be displayed on question field 602. In one embodiment, the question field may also include representation of a quantity of objects 603 displayed on the question field. In a bottom half of the screen/page an answer field is provided. The answer field may include, in various embodiments, the fields 604, 605, 606, any one of which may include the correct answer, that when selected may provide the correct answer, may include, but not be limited to a white, colored, textured, etc. . . . background field upon which numbers, objects, or number words are displayed. As shown in FIG. 6, the answer field may include a random numeral, for example, “13” 607 in field 604, “11” 608 in field 605, and “12” 609 in field 606, which may correspond to number words on answer field. The answer field may also include number words that may correspond to the random numerals, for example, “ten three” 610 in field 604 corresponding to “13” 607, “ten one” 611 in field 605 corresponding to “11” 608, and “ten two” 612 in field 606 corresponding to “12” 609. The number words contain place value for any number that ends in 11-99 and/or contains a period value that ends in 11-99, in accordance with embodiments of the present invention.

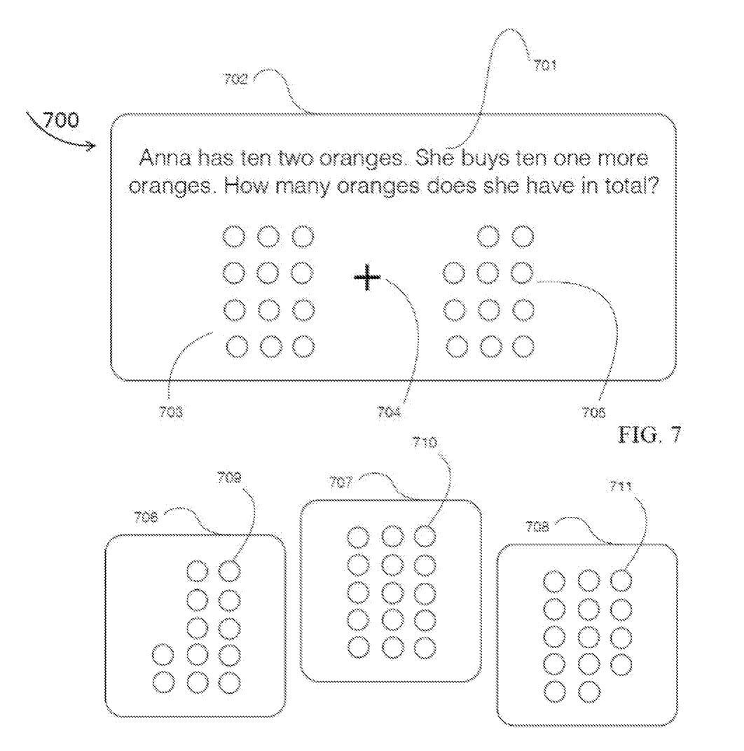

Referring to FIG. 7, is illustrated an interface 700 for mathematical operations for use in an exemplary method for providing a number sense to a user, in accordance with an embodiment of the present invention. Accordingly, FIG. 7 provides an interface drawing representative of the “Sentence” category of games described herein above. In this game, math instructions will be described in detail with a focus on storytelling and the written word. In this case, the question sentence features number words that utilize the “Ten One” format from FIG. 2 and FIG. 3. The question area (shown at the top of screen in this figure) will also display a representational image of a number of objects. In this example, an addition (+) operator is displayed so the user will know to add the two groups of objects. Other operators could be used instead such as subtract, multiply or divide. In the answer area, users can select from multiple answers. In this figure, answers feature “Ten One” number words which utilize format provided in FIG. 2 and FIG. 3. Accordingly, in a top half of the screen/page a descriptive instruction in sentence format 701 may be displayed on question field 702. In one embodiment, the question field may also include representation of a quantity of objects 703 displayed on the question field. In this exemplary embodiment, the question field may include an operator 704 in line with the question, i.e., an addition operator (+) as mentioned above. In a bottom half of the screen/page an answer field is provided. The answer field may include, in various embodiments, the fields 706, 707, 708, any one of which may include the correct answer, that when selected may provide the correct answer, may include, but not be limited to a white, colored, textured, etc. . . . background field upon which numbers, objects, or number words are displayed. As shown in FIG. 7, the answer field may include a representation of a quantity of objects, for example, 709 in field 706, 710 in field 707, and 711 in field 708, which may correspond to number words on answer field. The answer field may also include number words that may correspond to the random numerals, for example, “ten two” XXX in field 706 corresponding to 709, “ten five” XXX in field 707 corresponding to 707, and “ten four” XXX in field 708 corresponding to 711. The number words contain place value for any number that ends in 11-99 and/or contains a period value that ends in 11-99, in accordance with embodiments of the present invention.

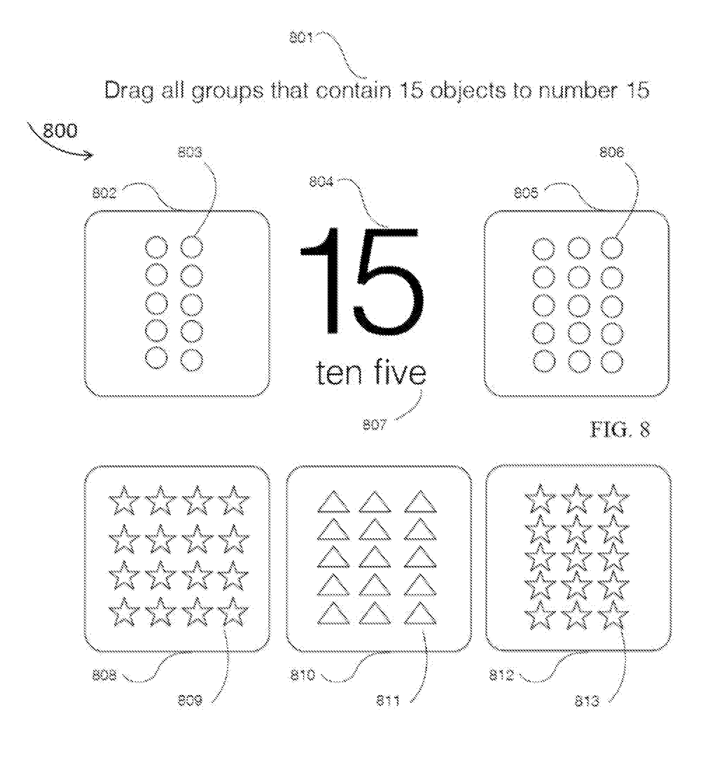

Referring to FIG. 8, is illustrated an interface 800 for mathematical operations for use in an exemplary method for providing a number sense to a user, in accordance with an embodiment of the present invention. Accordingly, FIG. 8 provides an interface drawing representative of the “Counting” category of games described herein above. In this game, math instructions will display random numerals, so each question may not always be the same on replay. Numerals may be selected within a range that correspond with the user's selected difficulty level. As described with reference to FIG. 1, user may follow instructions to drag and drop each group of objects that contain the correct number of objects to the number seen in the exemplary embodiment, shown in FIG. 8. In an embodiment, when one of the correct answers is dragged and dropped on the target number, a reward message may be displayed. In an embodiment, when an incorrect answer is dragged and dropped on the number, the user may get a fail message and may have the ability to retry. Once the user is able to obtain all the correct answers by dragging the answers to the number target for a question, the user may then proceed to the next question. Accordingly, in an exemplary embodiment shown in FIG. 8, instructions for a game are written in a top half of the screen/page, i.e., “drag all groups that contain 15 objects to number 15” 801. In one embodiment, the question field may include a random numeral target number, “15” 804 and a number name “ten five” 807 associated with the random numeral. In one embodiment, the answer field may include representation of a different quantity of objects displayed on multiple sections of the question field. In this exemplary embodiment, the question field may include, a field 802 with objects 803, a field 805 with objects 806, a field 808 with objects 809, a field 810 with objects 811, and a field 812 with objects 813 placed around the random numeral 804. In various embodiments, the fields 802, 804, 806, 808, 810, and 812 any one or more of which may include the correct answer, that when selected may provide the correct answer, may include, but not be limited to, a white, colored, textured, etc. . . . background field upon which numbers, objects, or number words are displayed which may correspond to number words on answer field. In the exemplary embodiment, shown in FIG. 8, the number of objects in fields 805, 810, and 812 is 15, so any one or all of these if dragged and dropped on the target number 804, are the correct answers. In the exemplary embodiment, shown in FIG. 8, the number of objects in fields 802, and 808 is not 15, so these if dragged and dropped on the target number 804, are the incorrect answers

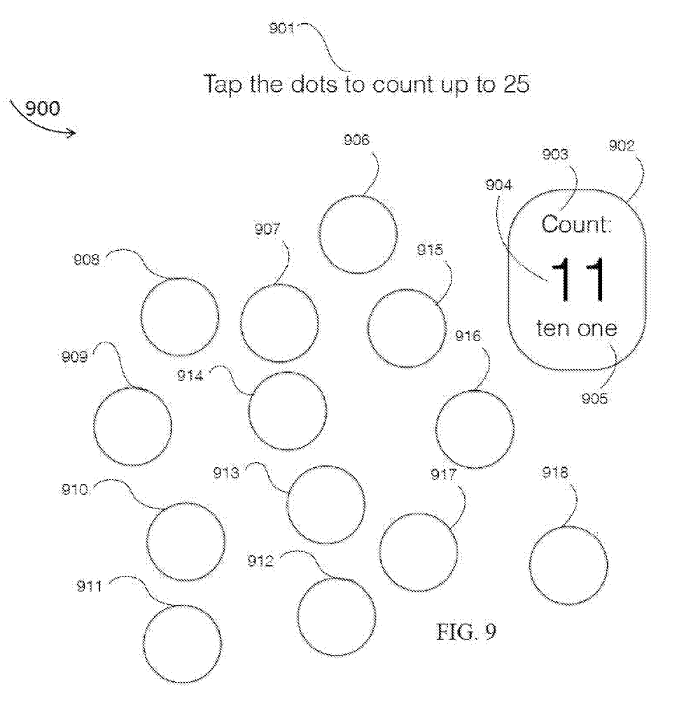

Referring to FIG. 9, is illustrated an interface 900 for mathematical operations for use in an exemplary method for providing a number sense to a user, in accordance with an embodiment of the present invention. Accordingly, FIG. 9 provides an interface drawing representative of the “Counting” category of games described herein above. In this game, user must tap all the objects which can be organized in columns, organized in rows or scattered. Each object tapped may disappear and count may be increased by a given interval to reach a target number in a target field. In the exemplary embodiment, described in FIG. 9, the interval is 1 as this is the default when no other interval amount is displayed. The count area may display number words in Ten One format as described in FIG. 2 and FIG. 3. Once the user is able to reach the target number, a reward message may be displayed, and the user may then proceed to the next question. Accordingly, in an exemplary embodiment shown in FIG. 9, instructions for a game are written in a top half of the screen/page, i.e., “tap the dots to count up to 25” 901. The instructions may contain the target number which player must achieve by tapping objects that appear in game area below, which in this exemplary embodiment, is 25. In one embodiment, a count field 902 may display the count 903 based on the number of taps made by a user, for example, “11” 904 a numeral equivalent to current count number, and a number name “ten one” 905 associated with the count reached with an interval of 1 as described herein above, i.e., number words equivalent to the current count number, using Ten One format as described in FIG. 2 and FIG. 3. So, to reach the count of 25 the user may have to tap another 14 objects, i.e., tap any one of objects 906-918 in order to increase current count number by a given interval.

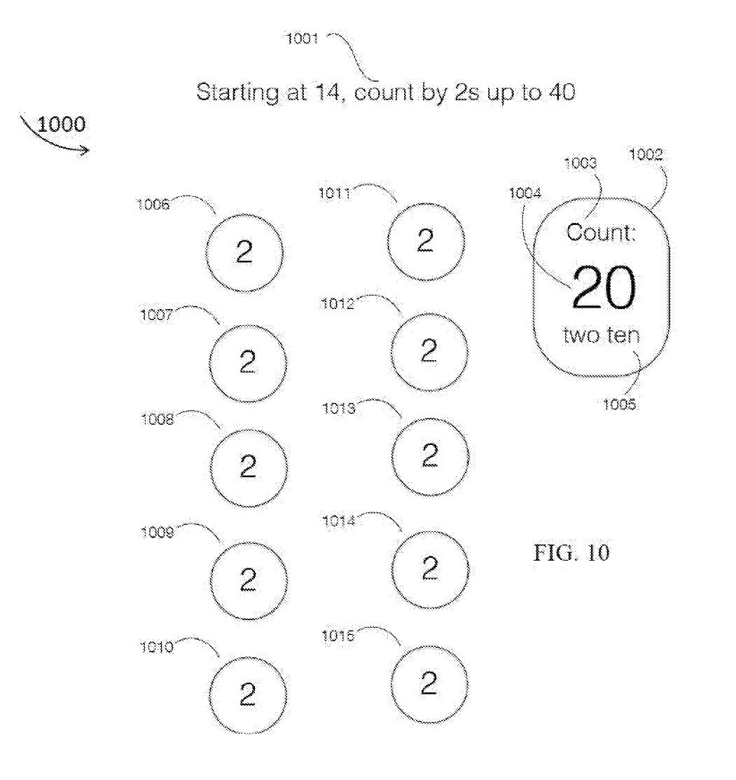

Referring to FIG. 10, is illustrated an interface 1000 for mathematical operations for use in an exemplary method for providing a number sense to a user, in accordance with an embodiment of the present invention. Accordingly, FIG. 10 provides an interface drawing representative of the “Counting” category of games described herein above. In this game, math instructions will display a starting number other than 0, an interval other than 1, and a target number—these are all selected at random from a range that is based on user's selected difficulty level. In this game, user must tap all the objects which can be organized in columns, organized in rows, or scattered. Each object tapped may disappear and count may be increased by a given interval to reach a target number in a target field. In the exemplary embodiment, described in FIG. 10, the interval is 2 as described in the instructions. Each object to be counted also displays the number 2. The count area may display number words in Ten One format as described in FIG. 2 and FIG. 3. Once the user is able to reach the target number, a reward message may be displayed, and the user may then proceed to the next question. Accordingly, in an exemplary embodiment shown in FIG. 10, instructions for a game are written in a top half of the screen/page, i.e., “starting at 14, count by 2s up to 40” 1001. The instructions may contain the start number, skip count interval, and target number which player must achieve by tapping objects that appear in game area below, which in this exemplary embodiment, is 40. In one embodiment, a count field 1002 may display the count 1003 based on the number of taps made by a user, for example, “20” 1004 a numeral equivalent to current count number, and a number name “two ten” 1005 associated with the count reached with an interval of 2 as described herein above, i.e., number words equivalent to the current count number, using Ten One format as described in FIG. 2 and FIG. 3. So, to reach the count of 40 the user may have to tap another 10 objects, i.e., tap any one of objects 1006-1015 in order to increase current count number by a given interval.

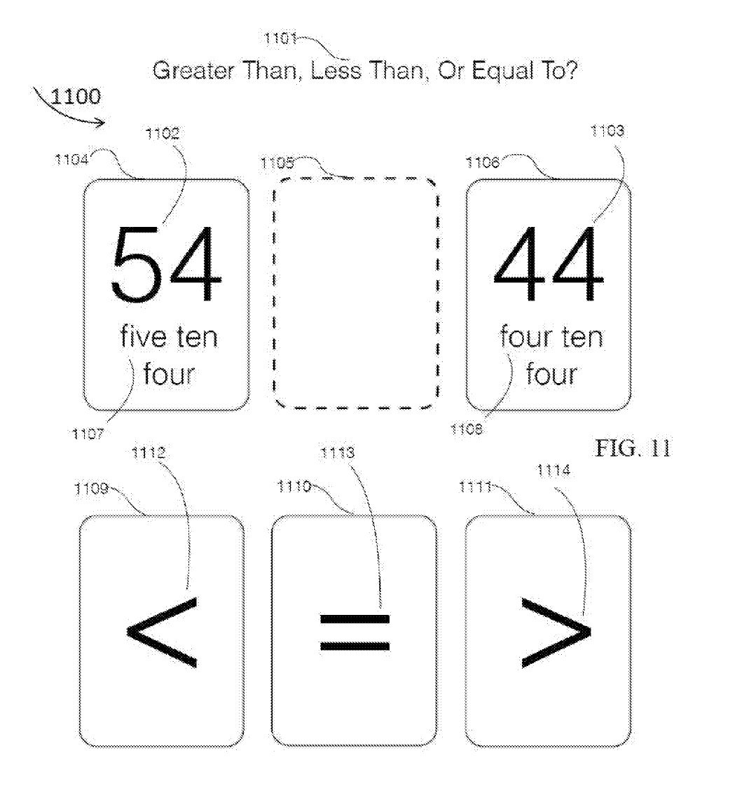

Referring to FIG. 11, is illustrated an interface 1100 for mathematical operations for use in an exemplary method for providing a number sense to a user, in accordance with an embodiment of the present invention. Accordingly, FIG. 11 provides an interface drawing representative of the “Greater Than, Less Than, or Equal To” category of games described herein above. In this game, math instructions may display greater than, less than, or equals questions with random answers. Ten One number words will be displayed on a field. In this example, the corresponding numeral is written above the number words on the same field. Note that the number words utilize format provided in FIG. 2 and FIG. 3. Numeral and number words displayed will be selected at random within a range that corresponds with user's selected difficulty level. As described with reference to FIG. 1, the user must tap the correct answer from multiple choice answers at the bottom of the screen. In an embodiment, when a correct answer is tapped, the correct answer may move to the blank position in the question above, and a reward message may be displayed. In an embodiment, when an incorrect answer is tapped, the user may get a fail message and may have the ability to retry until user taps the correct answer. Once the user is able to obtain the correct answer for a question, the user may then proceed to the next question. Accordingly, in an exemplary embodiment shown in FIG. 11, instructions for a game are written in a top half of the screen/page, i.e., “greater than, less than, or equal to” 1101. A question field, may include a random numeral “54” 1102 displayed on field 1104, which corresponds to number words “five ten four” 1107 on field 1104, a random numeral “44” 1103 is displayed on field 1106, which corresponds to number words “four ten four” 1108 on field 1106, a dashed line or “blank” field 1105. In various embodiments, the fields 1104, 1105, 1106 may include, but not be limited to a white, colored, textured, etc. . . . background field upon which numbers, objects or number words are displayed. In one embodiment, when a user taps any one of the field 1109, 1110, 1111 in the answer field that may display the correct answer, the correct answer field may move and occupy the position in the blank field 1105. Correct answer will appear on top of the blank, so that the blank will no longer be visible and the correct answer will be visible instead. In one embodiment, the number words 1107, 1108 may correspond to numeral 1102, 1103 respectively on field 1104, 1106 respectively. The number words contain place value for any number that ends in 11-99 and/or contains a period value that ends in 11-99. In various embodiments, the fields 1109, 1110, 1111, any one of which may include the correct answer, that when selected completes the requirement of the greater than, less than, or equal to sigh of field 1105, may include, but not be limited to a white, colored, textured, etc. . . . background field upon which the greater than, less than, and equal to signs may be shown. The answer field may include a less than sign, for example, “<” 1112 in field 1109, a equal to sign “=” 1113 in field 1110, and “>” 1114 in field 1111, which may correspond to the required answer in the blank field 1105. As mentioned with reference to FIG. 1, when a user/player selects the less than sign 1112, the equals sign 1113, and/or the greater than sign 1114, the designated software program will check to see if answer is correct.

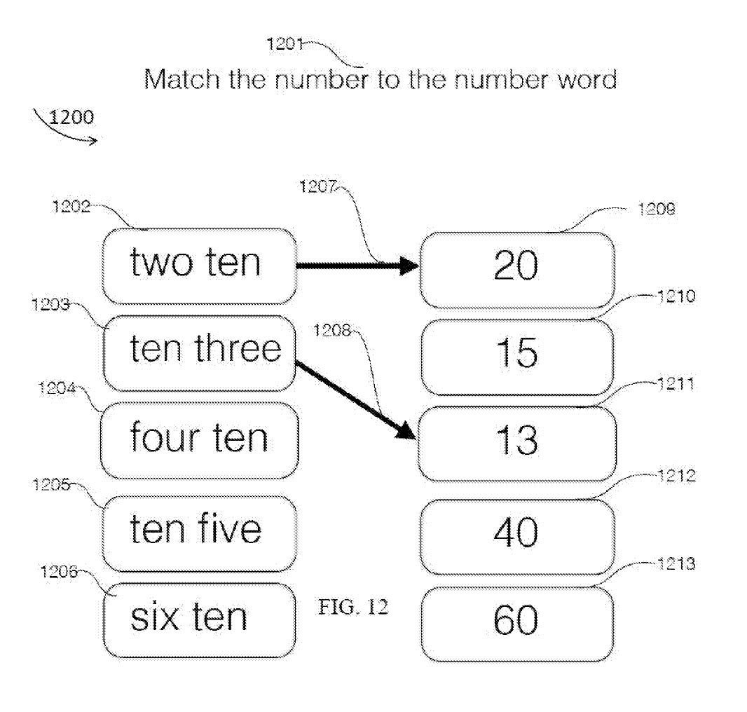

Referring to FIG. 12, is illustrated an interface 1200 for mathematical operations for use in an exemplary method for providing a number sense to a user, in accordance with an embodiment of the present invention. Accordingly, FIG. 12 provides an interface drawing representative of the “Matching” category of games described herein above. In this game, interface will display an equal number of “buttons” on left and right side of the screen. User is instructed to drag a button on the left to its corresponding button on the right. In this example, buttons on the left display number words while buttons on the right display numbers. In one embodiment, the numbers and number words may be switched to opposite sides in order to provide variety of gameplay. In one embodiment, the quantity of buttons on left and right may also be changed to provide variety of gameplay. In one embodiment, the number words utilize format provided in FIG. 2 and FIG. 3. Numeral and number words displayed may be selected at random within a range that corresponds with the user's selected difficulty level. As described with reference to FIG. 1, the user must drag the correct answer from multiple choice answers. In an embodiment, when all correct answers may have been selected, an arrow will display that connects the correct answers in the left and right sides, and a reward message may be displayed. In an embodiment, when an incorrect answer is selected, the user may get a fail message, for example, “X” in red font color, and the arrow will not connect between the left and right sides. In one embodiment, the user may have the ability to retry until user inputs all the correct answers. Once the user is able to obtain the correct answer for a question, the user may then proceed to the next question. Accordingly, in an exemplary embodiment shown in FIG. 12, instructions for a game are written in a top half of the screen/page, i.e., “match the number to the number word” 1201. On one half of the screen a left hand side field may include a plurality of buttons where a random number name may be displayed on each button, i.e., “two ten” 1202, “ten three” 1203, “four ten” 1204, “ten five” 1205, and “six ten” 1206. On another half of the screen a right hand side field may include a plurality of buttons where a random numeral name may be displayed on each button, i.e., “20” 1209, “15” 1210, “13” 1211, “40” 1212, and “60” 1213. I.e., a random numeral is displayed on answer field, which corresponds to number words on answer field. Once a user drags a correct left hand side number name button over a correct right hand side numeral button, for example, 1202 with number name two ten is dragged over 1209 with numeral 20; and 1203 with number name ten three is dragged over 1211 with numeral 13, an arrow 1207, 1208 respectively may connects button on left to corresponding button on right, where number word on one side of the screen correctly matches numeral on opposite side of screen.

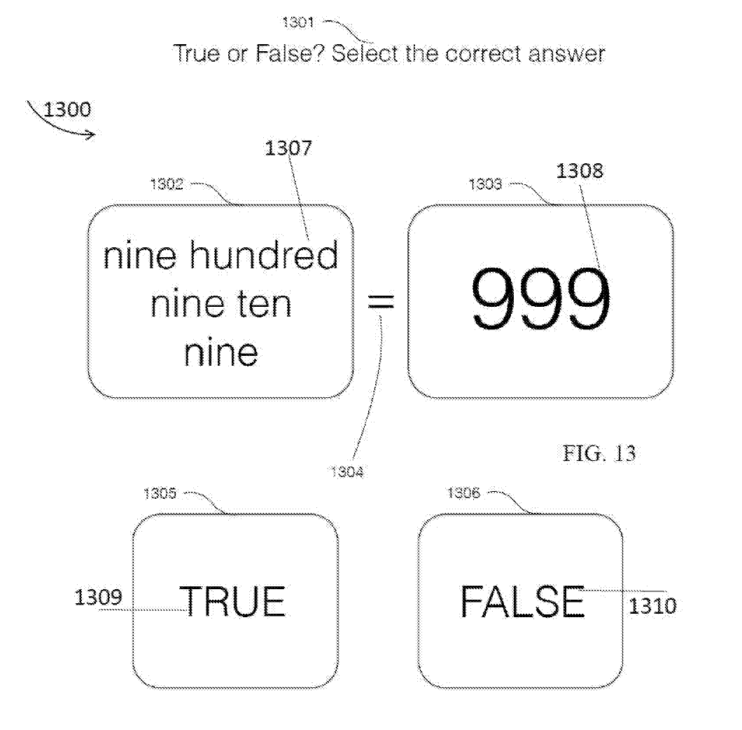

Referring to FIG. 13, is illustrated an interface 1300 for mathematical operations for use in an exemplary method for providing a number sense to a user, in accordance with an embodiment of the present invention. Accordingly, FIG. 13 provides an interface drawing representative of the “True or False” category of games described herein above. In this game, interface will display a comparison statement like greater than, less than or equal to between two fields on the left and right sides of the screen. In this example, number words (“nine hundred nine ten nine”) are displayed on the left field, while an equivalent number (999) is expressed on the right field. In this figure, the number words may utilize format provided in FIG. 2 and FIG. 3. Numerals and number words displayed will be selected at random within a range that corresponds with user's selected difficulty level. In one embodiment, below the comparison statement are two buttons labeled “true” and “false”. As described with reference to FIG. 1, the user must tap the correct answer from multiple choice answers at the bottom of the screen. In an embodiment, when a correct answer is input, a reward message may be displayed to the user. In an embodiment, when an incorrect answer is input, the user may get a fail message. In one embodiment, the user may have the ability to retry until user inputs the correct answer. In one embodiment, user may be shown the correct answer and a detailed explanation of why the correct answer is correct or why the incorrect answer is incorrect. Once the user is able to obtain the correct answer for a question, the user may then proceed to the next question. Accordingly, in the exemplary embodiment, shown in FIG. 13, instructions for the game may be written at the top of the screen, i.e., “true or false? Select the correct answer” 1301. A question field, may include a number name “nine hundred nine ten nine” 1307 displayed on field 1302, a random numeral “999” 1308 displayed on field 1303, and a comparison operator like “>”, “<”, or “=”n equal to, between the two fields 1302 and 1308, which is an equal to operator 1304 in the exemplary embodiment described in FIG. 13. In various embodiments, the fields 1302 and 1303 may include, but not be limited to a white, colored, textured, etc. . . . background field upon which numbers, objects or number words are displayed. The lower half of the screen may include buttons, button 1305 displaying label “true” 1309, and 1306 displaying label “false” 1310. In one embodiment, when a user taps any one of the button 1305 or 1306 it may display the correct operator answer in 1304. The number words contain accurate place value for any number that ends in 11-99 and/or contains a period value that ends in 11-99, in accordance with embodiments of the present invention.

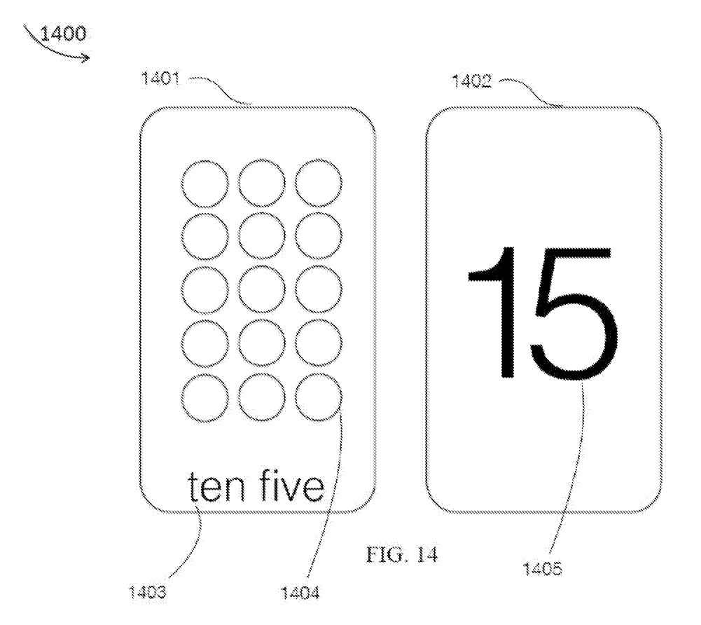

Referring to FIG. 14, is illustrated an interface 1400 for mathematical operations for use in an exemplary method for providing a number sense to a user, in accordance with an embodiment of the present invention. Accordingly, FIG. 14 provides an interface drawing representative of two sides of a field that may be displayed in any game described herein above. In an exemplary embodiment, on the left the “front” side of the field is illustrated, wherein a group of objects may be displayed with corresponding number words/name. At random intervals, the field may appear to flip and the “back” side of the field may be displayed. In an event, when the back side is displayed, the front side of the field may be hidden and vice versa. At the right may be illustrated the back side of the field, wherein a numeral is displayed to correspond with the value/number words displayed on the front side of the field. In an exemplary embodiment, illustrated in FIG. 14, 15 objects are displayed on the front side as circles, with corresponding number words “ten five”) below. Also in this example, the numeral 15 is displayed on the back side of the field. In one embodiment, the number words may utilize the format provided in FIG. 2 and FIG. 3. In one embodiment, the quantity of objects, numerals and number words displayed may be selected at random within a range that corresponds with the user's selected difficulty level. Accordingly, in the embodiment illustrated in FIG. 14, a front side of a field 1401 is shown to include objects 1404, and number words corresponding to the quantity of objects 1403. A back side of a field 1402 is shown to include a random numeral 1405, corresponding to the quantity of objects 1404 in the front side. In various embodiments, the fields 1401, 1402 may include, but not be limited to a white, colored, textured, etc. . . . background field upon which numbers, objects or number words are displayed.

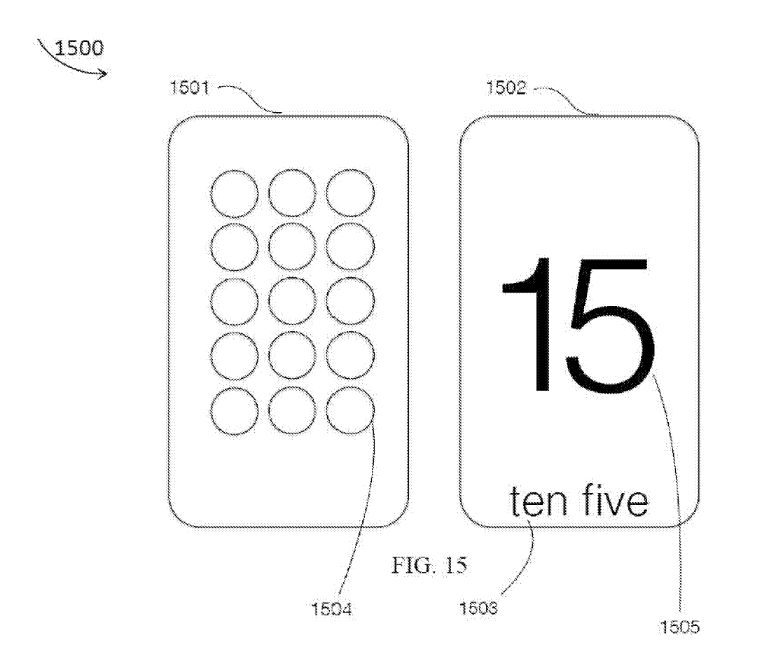

Referring to FIG. 15, is illustrated an interface 1500 for mathematical operations for use in an exemplary method for providing a number sense to a user, in accordance with an embodiment of the present invention. Accordingly, FIG. 15 provides an interface drawing representative of two sides of a field that may be displayed in any game described herein above. In an exemplary embodiment, on the left the “front” side of the field is illustrated, wherein a group of objects may be displayed. At random intervals, the field may appear to flip and the “back” side of the field may be displayed. In an event, when the back side is displayed, the front side of the field may be hidden and vice versa. At the right may be illustrated the back side of the field, wherein a random numeral is displayed along with number words to correspond with the value displayed on the front side of the field. In an exemplary embodiment, illustrated in FIG. 15, 15 objects are displayed on the front side as circles. Also in this example, the numeral 15 is displayed on the back side of the field with corresponding number words “ten five” below. In one embodiment, the number words may utilize the format provided in FIG. 2 and FIG. 3. In one embodiment, the quantity of objects, numerals and number words displayed may be selected at random within a range that corresponds with the user's selected difficulty level. Accordingly, in the embodiment illustrated in FIG. 15, a front side of a field 1501 is shown to include objects 1504. A back side of a field 1502 is shown to include a random numeral “15” 1505, corresponding to the quantity of objects 1504 in the front side and, and number words “ten five” 1503 corresponding to the quantity of objects 1504. In various embodiments, the fields 1501, 1502 may include, but not be limited to a white, colored, textured, etc. . . . background field upon which numbers, objects or number words are displayed.

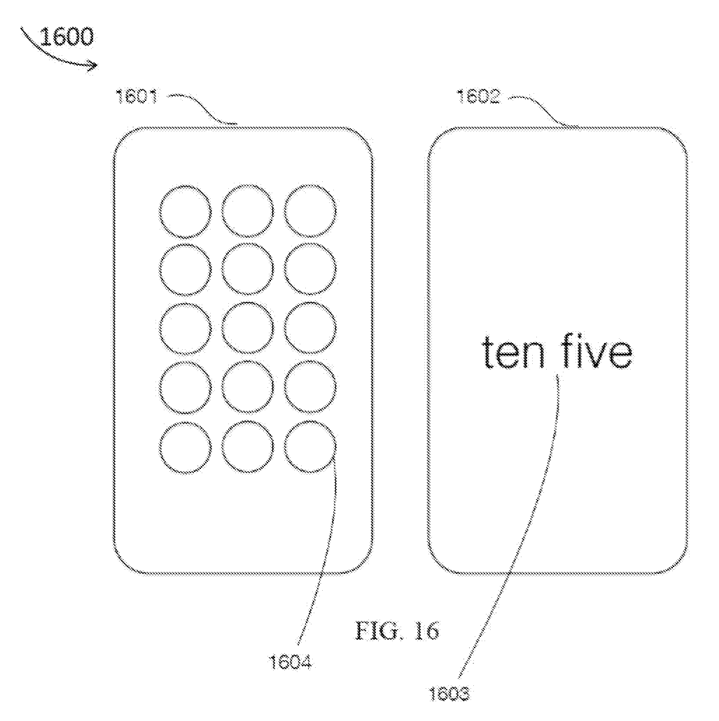

Referring to FIG. 16, is illustrated an interface 1600 for mathematical operations for use in an exemplary method for providing a number sense to a user, in accordance with an embodiment of the present invention. Accordingly, FIG. 16 provides an interface drawing representative of two sides of a field that may be displayed in any game described herein above. In an exemplary embodiment, on the left the “front” side of the field is illustrated, wherein a group of objects may be displayed. At random intervals, the field may appear to flip and the “back” side of the field may be displayed. In an event, when the back side is displayed, the front side of the field may be hidden and vice versa. At the right may be illustrated the back side of the field, wherein a number word is displayed which may correspond with the value displayed on the front side of the field. In an exemplary embodiment, illustrated in FIG. 16, 15 objects are displayed on the front side as circles. Also in this example, the number word “ten five” is displayed on the back side of the field corresponding to the quantity of objects displayed on the front side. In one embodiment, the number words may utilize the format provided in FIG. 2 and FIG. 3. In one embodiment, the quantity of objects, and number words displayed may be selected at random within a range that corresponds with the user's selected difficulty level. Accordingly, in the embodiment illustrated in FIG. 16, a front side of a field 1601 is shown to include objects 1604. A back side of a field 1602 is shown to include number words “ten five” 1603 corresponding to the quantity of objects 1604. In various embodiments, the fields 1601, 1602 may include, but not be limited to a white, colored, textured, etc. . . . background field upon which numbers, objects or number words are displayed.

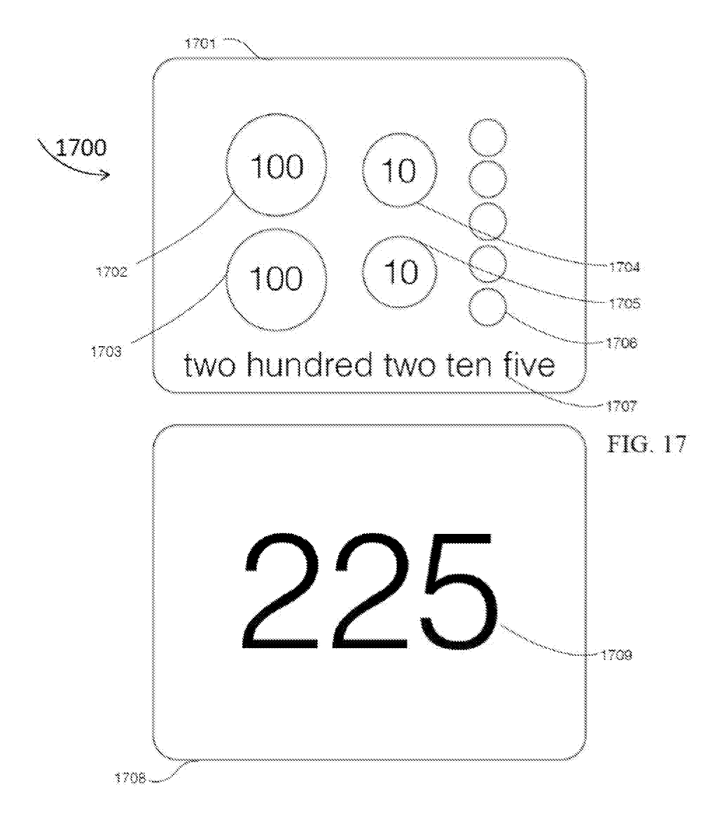

Referring to FIG. 17, is illustrated an interface 1700 for mathematical operations for use in an exemplary method for providing a number sense to a user, in accordance with an embodiment of the present invention. Accordingly, FIG. 17 provides an interface drawing representative represents two sides of a field that can be displayed in any game with reference to the embodiments disclosed herein. In an exemplary embodiment, at the top of a screen, a “front” side of the field is illustrated, wherein a group of objects is displayed with a corresponding number word below that includes the entire group of objects. At the bottom of the screen, the “back” side of the field is illustrated, wherein a numeral is displayed which may correspond to the number word displayed on the front side of the field. In one embodiment, at random interval, the field may appear to flip and the “back” side of the field may be displayed. In one embodiment, when the back side is displayed, the front side of the field may be hidden and vice versa. In an exemplary embodiment, illustrated in FIG. 17, 225 objects are displayed on the front side as circles It may be appreciated by a person with ordinary skill in the art, in light of and in accordance with the teachings of the present invention, that shapes other than circles, like polygons, pictorial representations, may also be used to display the numerals. In an exemplary embodiment, on a front side of field 1701, two larger circles 1702, 1703 may display numbers in the center, i.e., 100; two medium sized circles 1704, 1705 may display numbers in the center, i.e., 10; five smaller circles 1706 may have no number labels and the default value for these circles may be 1; and at the bottom of the front side of the field 1701 may be displayed the number words “two hundred two ten five” 1707. In an exemplary embodiment, on the back side of a field 1708, a numeral corresponding to the cumulative number value of the circles, i.e., 225 1709 may be displayed. In one embodiment, the number words may utilize the format provided in FIG. 2 and FIG. 3. In various embodiments, quantity of objects and number words displayed may be selected at random within a range that corresponds with user's selected difficulty level. In various embodiments, the fields 1701, 1709 may include, but not be limited to a white, colored, textured, etc. . . . background field upon which numbers, objects or number words are displayed.

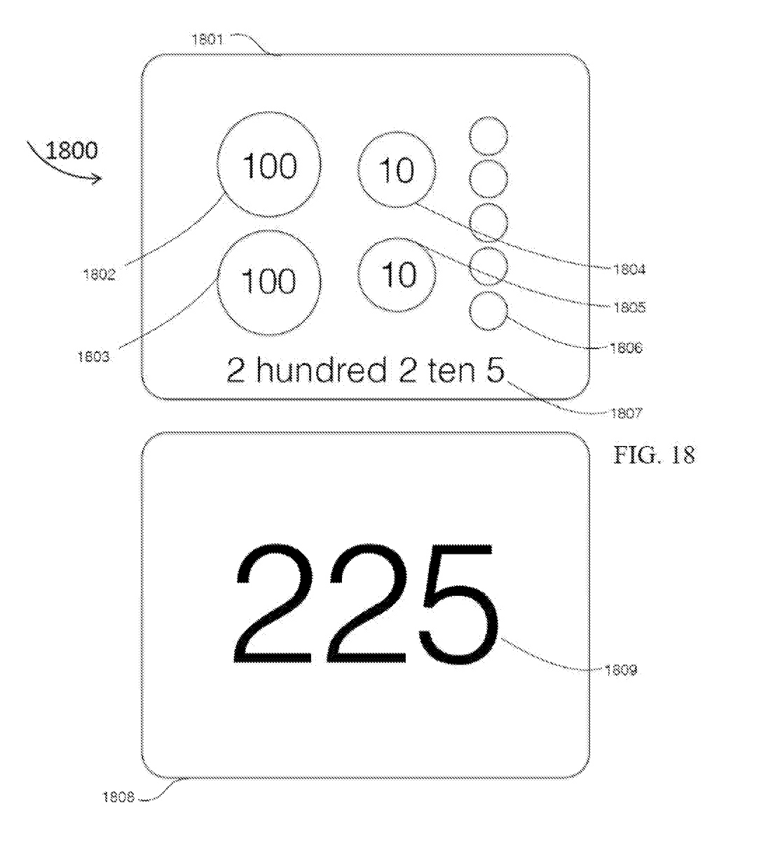

Referring to FIG. 18, is illustrated an interface 1800 for mathematical operations for use in an exemplary method for providing a number sense to a user, in accordance with an embodiment of the present invention. Accordingly, FIG. 18 provides an interface drawing representative represents two sides of a field that can be displayed in any game with reference to the embodiments disclosed herein. In an exemplary embodiment, at the top of a screen, a “front” side of the field is illustrated, wherein a group of objects is displayed with a corresponding number word below that includes the entire group of objects. At the bottom of the screen, the “back” side of the field is illustrated, wherein a numeral is displayed which may correspond to the number word displayed on the front side of the field. In one embodiment, at random interval, the field may appear to flip and the “back” side of the field may be displayed. In one embodiment, when the back side is displayed, the front side of the field may be hidden and vice versa. In an exemplary embodiment, illustrated in FIG. 18, 225 objects are displayed on the front side as circles. It may be appreciated by a person with ordinary skill in the art, in light of and in accordance with the teachings of the present invention, that shapes other than circles, like polygons, pictorial representations, may also be used to display the numerals. In an exemplary embodiment, on a front side of field 1801, two larger circles 1802, 1803 may display numbers in the center, i.e., 100; two medium sized circles 1804, 1805 may display numbers in the center, i.e., 10; five smaller circles 1806 may have no number labels and the default value for these circles may be 1; and at the bottom of the front side of the field 1801 may be displayed the numerals in the ones place (mixed modular numeral and number word), i.e., “2 hundred 2 ten 5” 1807. In an exemplary embodiment, on the back side of a field 1808, a numeral corresponding to the cumulative number value of the circles, i.e., 225 1809 may be displayed. In one embodiment, the number words may utilize the format provided in FIG. 2 and FIG. 3. In various embodiments, quantity of objects and number words displayed may be selected at random within a range that corresponds with user's selected difficulty level. In various embodiments, the fields 1801, 1809 may include, but not be limited to a white, colored, textured, etc. . . . background field upon which numbers, objects or number words are displayed.

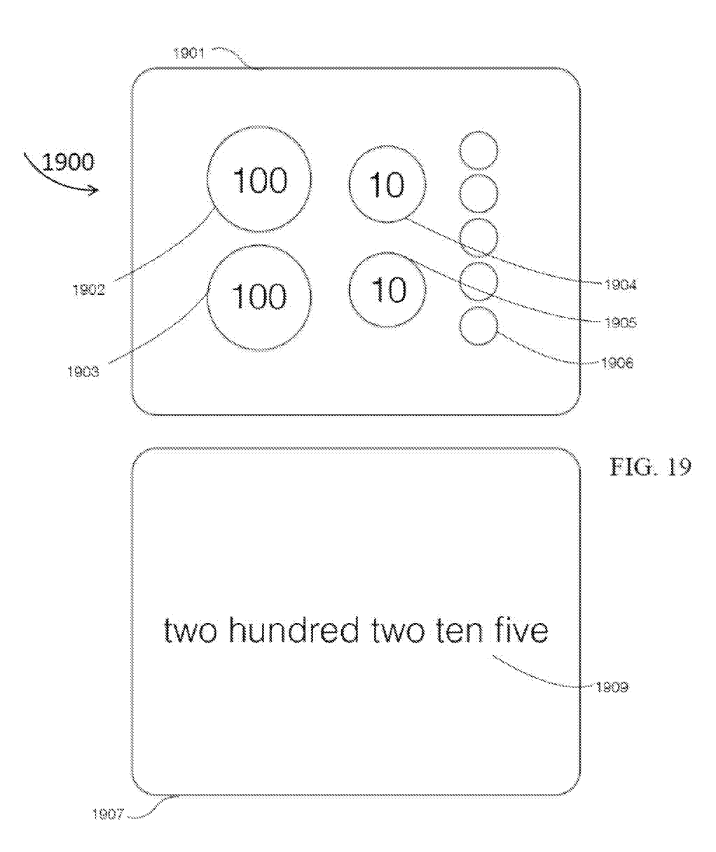

Referring to FIG. 19, is illustrated an interface 1900 for mathematical operations for use in an exemplary method for providing a number sense to a user, in accordance with an embodiment of the present invention. Accordingly, FIG. 19 provides an interface drawing representative represents two sides of a field that can be displayed in any game with reference to the embodiments disclosed herein. In an exemplary embodiment, at the top of a screen, a “front” side of the field is illustrated, wherein a group of objects is displayed. At the bottom of the screen, the “back” side of the field is illustrated, wherein a numeral is displayed which may correspond to the cumulative quantity of objects displayed on the front side of the field. In one embodiment, at random interval, the field may appear to flip and the “back” side of the field may be displayed. In one embodiment, when the back side is displayed, the front side of the field may be hidden and vice versa. In an exemplary embodiment, illustrated in FIG. 19, 225 objects are displayed on the front side as circles. It may be appreciated by a person with ordinary skill in the art, in light of and in accordance with the teachings of the present invention, that shapes other than circles, like polygons, pictorial representations, may also be used to display the numerals. In an exemplary embodiment, on a front side of field 1901, two larger circles 1902, 1903 may display numbers in the center, i.e., 100; two medium sized circles 1904, 1905 may display numbers in the center, i.e., 10; and five smaller circles 1906 may have no number labels and the default value for these circles may be 1. In an exemplary embodiment, on the back side of a field 1907, a number word corresponding to the cumulative number value of the circles, i.e., “two hundred two ten five” 1909 may be displayed. In one embodiment, the number words may utilize the format provided in FIG. 2 and FIG. 3. In various embodiments, quantity of objects and number words displayed may be selected at random within a range that corresponds with user's selected difficulty level. In various embodiments, the fields 1901, 1907 may include, but not be limited to a white, colored, textured, etc. . . . background field upon which numbers, objects or number words are displayed.

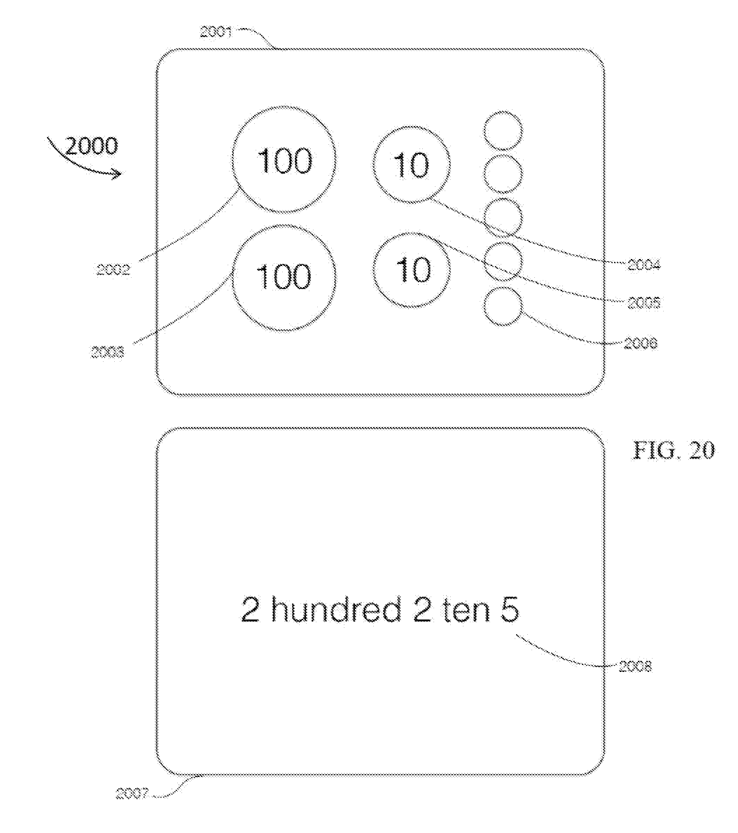

Referring to FIG. 20, is illustrated an interface 2000 for mathematical operations for use in an exemplary method for providing a number sense to a user, in accordance with an embodiment of the present invention. Accordingly, FIG. 20 provides an interface drawing representative represents two sides of a field that can be displayed in any game with reference to the embodiments disclosed herein. In an exemplary embodiment, at the top of a screen, a “front” side of the field is illustrated, wherein a group of objects is displayed. At the bottom of the screen, the “back” side of the field is illustrated, wherein a numeral is displayed which may correspond to the cumulative quantity of objects displayed on the front side of the field. In one embodiment, at random interval, the field may appear to flip and the “back” side of the field may be displayed. In one embodiment, when the back side is displayed, the front side of the field may be hidden and vice versa. In an exemplary embodiment, illustrated in FIG. 20, 225 objects are displayed on the front side as circles. It may be appreciated by a person with ordinary skill in the art, in light of and in accordance with the teachings of the present invention, that shapes other than circles, like polygons, pictorial representations, may also be used to display the numerals. In an exemplary embodiment, on a front side of field 2001, two larger circles 2002, 2003 may display numbers in the center, i.e., 100; two medium sized circles 1904, 2005 may display numbers in the center, i.e., 10; and five smaller circles 2006 may have no number labels and the default value for these circles may be 1. In an exemplary embodiment, on the back side of a field 2007, a mixed modular numeral and number word corresponding to the cumulative number value of the circles, i.e., “2 hundred 2 ten 5” 2008 may be displayed. In one embodiment, the number words may utilize the format provided in FIG. 2 and FIG. 3. In various embodiments, quantity of objects and number words displayed may be selected at random within a range that corresponds with user's selected difficulty level. In various embodiments, the fields 2001, 2007 may include, but not be limited to a white, colored, textured, etc. . . . background field upon which numbers, objects or number words are displayed.

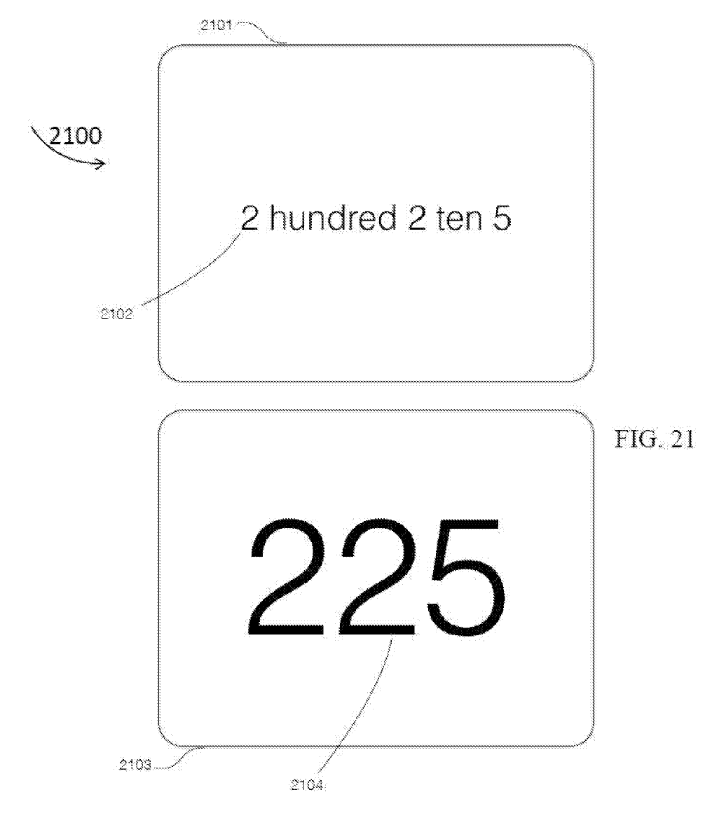

Referring to FIG. 21, is illustrated an interface 2100 for mathematical operations for use in an exemplary method for providing a number sense to a user, in accordance with an embodiment of the present invention. Accordingly, FIG. 21 provides an interface drawing representative represents two sides of a field that can be displayed in any game with reference to the embodiments disclosed herein. In an exemplary embodiment, at the top of a screen, a “front” side of the field is illustrated, wherein a mixed modular display of number word and numerals is displayed which correspond to the value displayed on a back side of the field. At the bottom of the screen, the “back” side of the field is illustrated, wherein a numeral is displayed which may correspond to the mixed modular display of number word and numerals displayed on the front side of the field. In one embodiment, at random interval, the field may appear to flip and the “back” side of the field may be displayed. In one embodiment, when the back side is displayed, the front side of the field may be hidden and vice versa. In an exemplary embodiment, illustrated in FIG. 21, on the front side 2101 a modular display of number word and numerals displayed, i.e., “2 hundred 2 ten 5” 2102. In an exemplary embodiment, on the back side of a field 2103, a numeral “225” 2104 corresponding to the mixed modular numeral and number word may be displayed. In one embodiment, the number words may utilize the format provided in FIG. 2 and FIG. 3. In various embodiments, quantity of objects and number words displayed may be selected at random within a range that corresponds with user's selected difficulty level. In various embodiments, the fields 2101, 2103 may include, but not be limited to a white, colored, textured, etc. . . . background field upon which numbers, objects or number words are displayed.

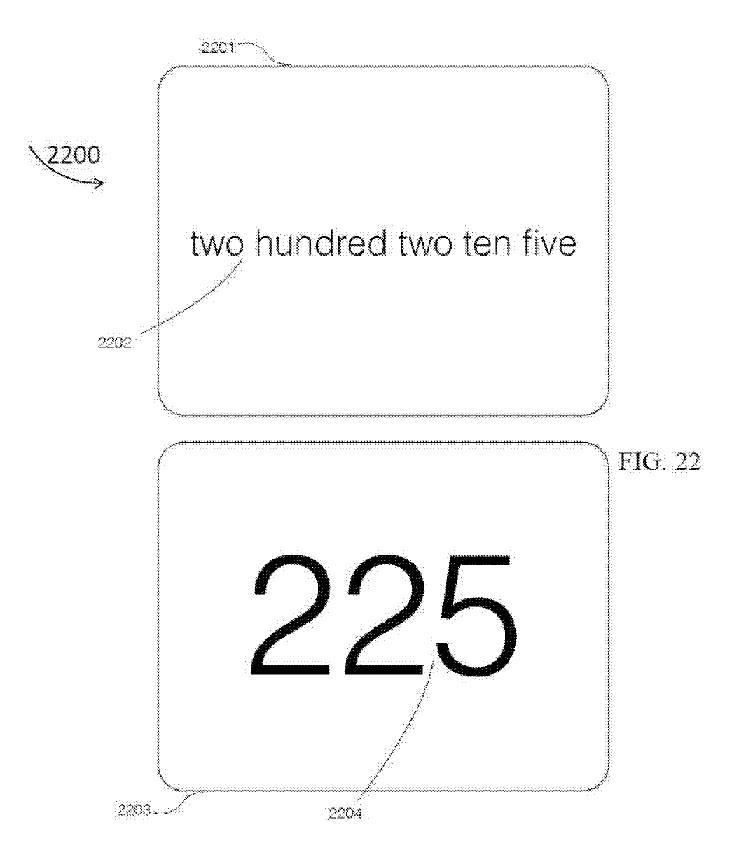

Referring to FIG. 22, is illustrated an interface 2100 for mathematical operations for use in an exemplary method for providing a number sense to a user, in accordance with an embodiment of the present invention. Accordingly, FIG. 21 provides an interface drawing representative represents two sides of a field that can be displayed in any game with reference to the embodiments disclosed herein. In an exemplary embodiment, at the top of a screen, a “front” side of the field is illustrated, wherein a number word is displayed which correspond to the value displayed on a back side of the field. At the bottom of the screen, the “back” side of the field is illustrated, wherein a numeral is displayed which may correspond to the number word displayed on the front side of the field. In one embodiment, at random interval, the field may appear to flip and the “back” side of the field may be displayed. In one embodiment, when the back side is displayed, the front side of the field may be hidden and vice versa. In an exemplary embodiment, illustrated in FIG. 22, on the front side 2201 a number word is displayed, i.e., “two hundred two ten five” 2202. In an exemplary embodiment, on the back side of a field 2203, a numeral “225” 2204 corresponding to the number word may be displayed. In one embodiment, the number words may utilize the format provided in FIG. 2 and FIG. 3. In various embodiments, quantity of objects and number words displayed may be selected at random within a range that corresponds with user's selected difficulty level. In various embodiments, the fields 2201, 2203 may include, but not be limited to a white, colored, textured, etc. . . . background field upon which numbers, objects or number words are displayed.

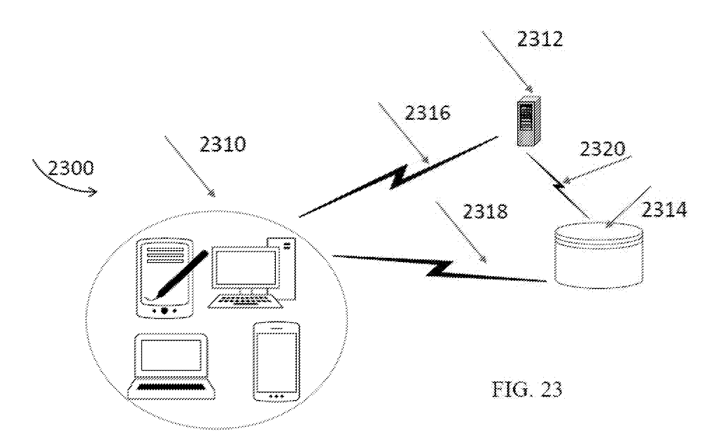

Referring to FIG. 23, is illustrated an exemplary system 2300 for providing a number sense to a user, in accordance with an embodiment of the present invention. In an exemplary embodiment, the system 2300 a computer system 2310, wherein the computer system 2310 includes the designated software program for providing a number sense to a user, in accordance with an embodiment of the present invention. In certain embodiments, the system may include a server 2312 and a database 2314. The computer system 2310 is communicably connected 2316 to the server 2312 and the server 2312 is communicably connected 2320 to the database 2314. A computer system 112 may be virtually any device or devices capable of executing the designated software program for providing a number sense to a user, processing and analyzing the input from the user, and take necessary actions. In one embodiment, the designated software program may be delivered to the player/user using a computer system as described herein above. In various embodiments, the computer system may include, but is not limited to:

(1) a touch screen device, for example, a smart phone, a tablet, or a personal computer, wherein the user may select answer by tapping on a touch screen;

(2) a mouse-equipped device, for example, a personal computer, wherein the user may select answer by pointing and clicking on a personal computer screen using a mouse;

(3) a keyboard device, for example, a personal computer, a smart phone, or a tablet, wherein the user may select answer by navigating through answers using arrow keys or wasd—up is (w), left is (a), right is (d), down is (s)—and a button to select for example, enter or return. In another embodiment, the user may select answers by typing the answers into a physical or digital (on screen) keyboard and pressing enter or return or done to enter;

(4) a joystick selector, a track pad and/or buttons as part of a console device that may work with a remote monitor or television or has its own display screen, wherein, a user may select an answer by using the joystick, the track pad and/or the buttons with a console device that works with a television or a monitor screen. In another embodiment, the user may select an answer by using a joystick, track pad and/or buttons with a standalone console device that may include a display screen;

(5) a tv remote wherein a user may select an answer by pointing a television remote control towards an intended answer appearing on the television display screen, and using a typical remote-enabled selection method, i.e., clicking a button or speaking a voice command;

(6) virtual reality (VR) headset or VR glasses, with or without VR gloves or hand input, wherein, a user may select an answer by wearing a VR headset or VR glasses and select the answer by pointing a VR hand or finger. In another embodiment, a user may select answer by wearing a VR headset or VR glasses and directing focus toward an answer to select;

(7) a microphone input wherein a user may select answer by speaking the selected answer into a microphone; and the like. Other selection tools for differently abled learners may include retina selection where user's eye position is tracked in order to input answers, muscle-based selection where user's muscle movements are measured in order to provide input, or brain-activity based selection where user's brain activity is measured in order to make selection, and the like.

In certain embodiments, the computer system 2310 may be communicably connected to the server 2312 and to a database 2314. Server 2312 may be any computing platform that executes computer software and/or code from a non-transitory computer readable medium. Server 2312 may also access a database 2314 including the various exemplary embodiments described herein above and information for authentication of the user. In some embodiments, system 2300 may comprise two or more computer systems 2310, two or more servers 2312 with databases 2314.

It may be appreciated by a person with ordinary skill in the art, in light of and in accordance with the teachings of the present invention, that any number of computer systems may connect with each other with virtually any wired and/or wireless means. The computer system may connect by any virtual means including, but not limited to, Bluetooth® connection, Ethernet cable, USB cable, WI-FI, IRDA, etc.

It may be appreciated by a person with ordinary skill in the art, in light of and in accordance with the teachings of the present invention, a server 2312 may be virtually any computing platform such as, but not limited to, a computer cluster, a laptop, a tablet, a smartphone, etc. In another embodiment of the present invention, server 2312 may be a computer connected to a computer system 2310 via a USB cable.

It may be appreciated by a person with ordinary skill in the art, in light of and in accordance with the teachings of the present invention, a database 2314 may be virtually any data storage device or devices. Database 2314 may be, but not limited to, a plurality of data servers, a memory card. In another embodiment of the present invention, database 2314 may be a memory card connected to server 2312.

It may be appreciated by a person with ordinary skill in the art, in light of and in accordance with the teachings of the present invention, that database 2314 may contain virtually any data to improve the functionality of system 2300. Database 2314 may include, without limitation information on difficulty level, various math games, listing of number names, listing of modular number names with numerals, list of objects for displaying numerals, list of groups of objects with corresponding number words, and the like.

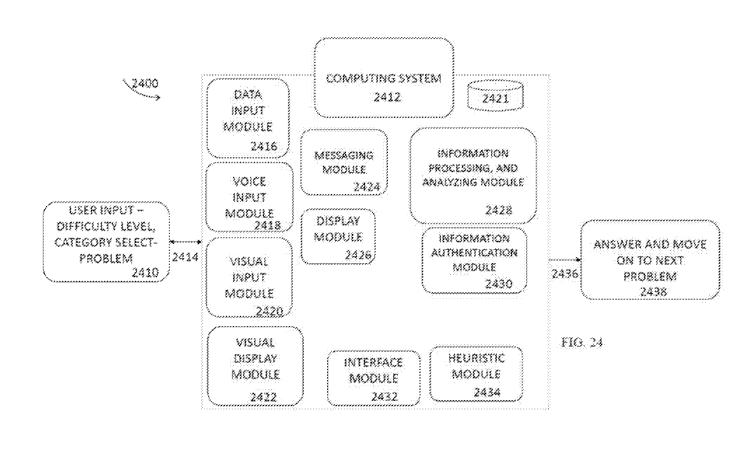

FIG. 24 illustrates an architecture 2400 of an exemplary computing system for providing a number sense to a user, in accordance with an embodiment of the present invention. The computing system 2412 including a designated software program for providing a number sense to a user architecture 2400 may comprise a data input module 2416, voice input module 2418, a visual input module 2420, a visual display module 2422, a messaging module 2424, a display module 2426, an information processing, and formatting module 2428, an information authentication module 2430, a database 2421, an interface module 2432, and a heuristic module 2430. A data input module 2416 may have a means of inputting the designated software program for providing number sense to a user, such as, without limitation, a processing unit, a computer, or a server 2312 to execute computer code and/or algorithms from a non-transitory computer readable medium, and receiving user input 2414 of difficulty level and category of game 2410 and providing output 2436 as an answer and the user may move on to next problem 2438. A voice input module 218 may have a means of capturing user input provided verbally, such as, without limitation, means of verbally inputting the designated software program for providing number sense to a user, such as, without limitation, a processing unit, a computer, or a server 2312 to execute computer code and/or algorithms from a non-transitory computer readable medium, and receiving user input 2414 of difficulty level and category of game 2410 and providing output 2436 as an answer and the user may move on to next problem 2438. A visual input module 220 may have a means of capturing user input provided visually, such as, without limitation, a means of visually inputting the designated software program for providing number sense to a user, such as, without limitation, a processing unit, a computer, or a server 2312 to execute computer code and/or algorithms from a non-transitory computer readable medium, and receiving user input 2414 of difficulty level and category of game 2410 and providing output 2436 as an answer and the user may move on to next problem 2438. A visual display module 222, may have a means of displaying visually the math problems and answers using a display screen of the computer system 2310, such as, without limitation, may have a means of displaying the designated software program for providing number sense to a user, such as, without limitation, a processing unit, a computer, or a server 2312 to execute computer code and/or algorithms from a non-transitory computer readable medium, and displaying to the user 2414 difficulty levels and category of game 2410 and displaying output 2436 as an answer and the user may move on to next problem 2438. A messaging module 2424, may have a means of providing a message using the designated software program for providing number sense to a user, such as, without limitation, a processing unit, a computer, or a server 2312 to execute computer code and/or algorithms from a non-transitory computer readable medium, and receiving user input 2414 of difficulty level and category of game 2410 and providing message output 2436 as a correct/incorrect answer and user may move on to next problem 2438. A display module 2426 may have a processing means such as, without limitation, a processing unit, a computer, or a server to execute computer code and/or algorithms from a non-transitory computer readable medium for providing a display to the user for the designated software program for providing number sense to a user, displaying user input 2414 of difficulty level and category of game 2410 and displaying output 2436 as an answer and user may move on to next problem 2438. Information processing and analyzing module 2428 may have a means of processing and analyzing a user input information for the designated software program for providing number sense to a user, such as, without limitation, a processing unit, a computer, or a server to execute computer code and/or algorithms from a non-transitory computer readable medium for the data 2410 input 2414 by the user. Information authentication module 2430 may have a means of authenticating a user, and a user input information such as, without limitation, a processing unit, a computer, or a server to execute computer code and/or algorithms from a non-transitory computer readable medium for authenticating a user using the designated software program for providing number sense to a user. An interface module 2432 may have a means of interfacing with the various modules, for example, a data input module 2416, voice input module 2418, a visual input module 2420, a visual display module 2422, a messaging module 2424, a display module 2426, an information processing, and formatting module 2428, an information authentication module 2430, a database 2421, such as, without limitation, a processing unit, a computer, or a server 2312 to execute computer code and/or algorithms from a non-transitory computer readable medium and provide interface support to assist the system 2400 in performing its various functions. A heuristic module 2434 may have a means of self-learning, such as, without limitation, a processing unit, a computer, or a server 2312 to execute computer code and/or algorithms from a non-transitory computer readable medium, to assist the assimilation of various user inputs on difficulty level and category selections while using the designated software program for providing number sense to a user.

It may be appreciated by a person with ordinary skill in the art, in light of and in accordance with the teachings of the present invention, that one or more modules may be embodied in a single device. In an alternative embodiment of the present invention, all modules except the data input module, visual input module, and vocal input module, may be embodied in a smartphone device which would be capable of using the designated software program for providing number sense to a user.

It may be appreciated by a person with ordinary skill in the art, in light of and in accordance with the teachings of the present invention, that virtually any algorithm and/or computer code may be used to recognize a visual input. Visual recognition algorithms and/or methods may include, without limitation, Bayesian networks, fuzzy logic, neural networks, template matching, Hidden Markov models, machine learning, data mining, feature extraction and data analysis/statistics, optical character recognition, etc. In an alternative embodiment of the present invention, a binary search tree may be implemented to extra data from a visual input.

It may be appreciated by a person with ordinary skill in the art, in light of and in accordance with the teachings of the present invention, that virtually any algorithm and/or computer code may be used to recognize a vocal input. Vocal/sound recognition algorithms and/or methods may include, without limitation, Bayesian networks, fuzzy logic, neural networks, template matching, Hidden Markov models, machine learning, data mining, feature extraction and data analysis/statistics, optical character recognition, etc. In an alternative embodiment of the present invention, a binary search tree may be implemented to extra data from a vocal input.

It may be appreciated by a person with ordinary skill in the art, in light of and in accordance with the teachings of the present invention, that there may be a plurality of the same modules in the system capable of using the designated software program for providing number sense to a user architecture 2400. A plurality of modules such as, without limitation, a data input module 2416, voice input module 2418, a visual input module 2420, a visual display module 2422, a messaging module 2424, a display module 2426, an information processing, and formatting module 2428, an information authentication module 2430, a database 2421, an interface module 2432, and a heuristic module 2430 may be present in the system capable of using the designated software program for providing number sense to a user architecture 2400. The plurality of similar modules may work in parallel or independently to improve the throughput and/or speed of the system capable of using the designated software program for providing number sense to a user architecture 2400. In an alternative embodiment of the present invention, a plurality of data input modules, visual input modules, and vocal input modules, may be connected to the system 2400 via wired and wireless connections to access resources from different wired and wireless networks. In still another alternative embodiment of the present invention, a plurality of similar modules may form a secondary system capable of using the designated software program for providing number sense to a user capable of seamlessly substituting a messing and/or failing module.

It may be appreciated by a person with ordinary skill in the art, in light of and in accordance with the teachings of the present invention, that one or more modules may transmit error information to a tech support server that is on an accessible network or over the internet. In an alternative embodiment of the present invention, additional error information may be sent to a server to alleviate processing load on the system capable of using the designated software program for providing number sense to a user.

In one embodiment, the system and method disclosed herein may include any designated software program for mat that may fit a category, such as, counting, greater than less than or equal to, true/false, sentence or matching, etc. . . . and displays ten one number words to represent a value such as 11, i.e. “ten one” instead of “eleven”. In certain embodiments, traditional classroom math education methods may incorporate embodiments of the invention disclosed herein, by using number words that contain accurate place value for any number that ends in 11-99 and/or contains a period value that ends in 11-99, for example in math textbooks, math workbooks or verbal math lessons.

In various embodiments, the number words described herein may be referred to as “ten one” number words, and a variety of software game types for math education using these “ten one” number words may be referred to as “Ten One Math”, “Ten One counting”, “Ten One number words”, “Ten One number words”, and the like. As used herein, the term “Ten One” is a reference to the first number word that is changed when counting up by ones, i.e., after number 10, the next number is 11 and the number word for 11 is “ten one”.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

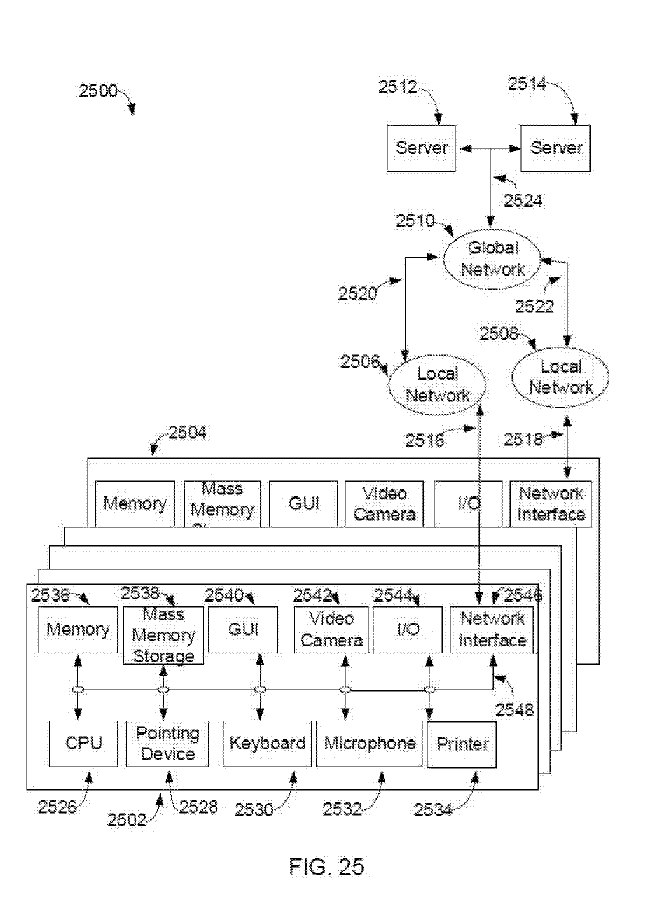

FIG. 25 is a block diagram depicting an exemplary client/server system which may be used by an exemplary web-enabled/networked embodiment of the present invention.

A communication system 2500 includes a multiplicity of clients with a sampling of clients denoted as a client 2502 and a client 2504, a multiplicity of local networks with a sampling of networks denoted as a local network 2506 and a local network 2508, a global network 2510 and a multiplicity of servers with a sampling of servers denoted as a server 2512 and a server 2514.

Client 2502 may communicate bi-directionally with local network 2506 via a communication channel 2516. Client 2504 may communicate bi-directionally with local network 2508 via a communication channel 2518. Local network 2506 may communicate bi-directionally with global network 2510 via a communication channel 2520. Local network 2508 may communicate bi-directionally with global network 2510 via a communication channel 2522. Global network 2510 may communicate bi-directionally with server 2512 and server 2514 via a communication channel 2524. Server 2512 and server 2514 may communicate bi-directionally with each other via communication channel 2524. Furthermore, clients 2502, 2504, local networks 2506, 2508, global network 2510 and servers 2512, 2514 may each communicate bi-directionally with each other.

In one embodiment, global network 2510 may operate as the Internet. It will be understood by those skilled in the art that communication system 2500 may take many different forms. Non-limiting examples of forms for communication system 2500 include local area networks (LANs), wide area networks (WANs), wired telephone networks, wireless networks, or any other network supporting data communication between respective entities.

Clients 2502 and 2504 may take many different forms. Non-limiting examples of clients 2502 and 2504 include personal computers, personal digital assistants (PDAs), cellular phones and smartphones.

Client 2502 includes a CPU 2526, a pointing device 2528, a keyboard 2530, a microphone 2532, a printer 2534, a memory 2536, a mass memory storage 2538, a GUI 2540, a video camera 2542, an input/output interface 2544 and a network interface 2546.

CPU 2526, pointing device 2528, keyboard 2530, microphone 2532, printer 2534, memory 2536, mass memory storage 2538, GUI 2540, video camera 2542, input/output interface 2544 and network interface 2546 may communicate in a unidirectional manner or a bi-directional manner with each other via a communication channel 2548. Communication channel 2548 may be configured as a single communication channel or a multiplicity of communication channels.

CPU 2526 may be comprised of a single processor or multiple processors. CPU 2526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 2536 is used typically to transfer data and instructions to CPU 2526 in a bi-directional manner. Memory 2536, as discussed previously, may include any suitable computer-readable media, intended for data storage, such as those described above excluding any wired or wireless transmissions unless specifically noted. Mass memory storage 2538 may also be coupled bi-directionally to CPU 2526 and provides additional data storage capacity and may include any of the computer-readable media described above. Mass memory storage 2538 may be used to store programs, data and the like and is typically a secondary storage medium such as a hard disk. It will be appreciated that the information retained within mass memory storage 2538, may, in appropriate cases, be incorporated in standard fashion as part of memory 2536 as virtual memory.

CPU 2526 may be coupled to GUI 2540. GUI 2540 enables a user to view the operation of computer operating system and software. CPU 2526 may be coupled to pointing device 2528. Non-limiting examples of pointing device 2528 include computer mouse, trackball and touchpad. Pointing device 2528 enables a user with the capability to maneuver a computer cursor about the viewing area of GUI 2540 and select areas or features in the viewing area of GUI 2540. CPU 2526 may be coupled to keyboard 2530. Keyboard 2530 enables a user with the capability to input alphanumeric textual information to CPU 2526. CPU 2526 may be coupled to microphone 2532. Microphone 2532 enables audio produced by a user to be recorded, processed and communicated by CPU 2526. CPU 2526 may be connected to printer 2534. Printer 2534 enables a user with the capability to print information to a sheet of paper. CPU 2526 may be connected to video camera 2542. Video camera 2542 enables video produced or captured by user to be recorded, processed and communicated by CPU 2526.

CPU 2526 may also be coupled to input/output interface 2544 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 2526 optionally may be coupled to network interface 2546 which enables communication with an external device such as a database or a computer or telecommunications or internet network using an external connection shown generally as communication channel 2516, which may be implemented as a hardwired or wireless communications link using suitable conventional technologies. With such a connection, CPU 2526 might receive information from the network, or might output information to a network in the course of performing the method steps described in the teachings of the present invention.

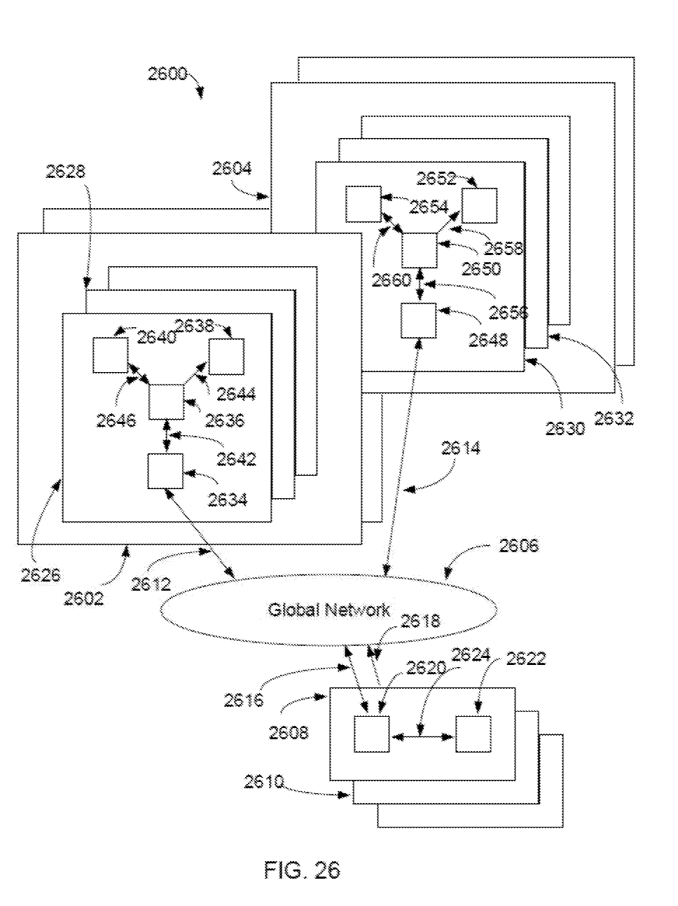

FIG. 26 illustrates a block diagram depicting a conventional client/server communication system, which may be used by an exemplary web-enabled/networked embodiment of the present invention.

A communication system 2600 includes a multiplicity of networked regions with a sampling of regions denoted as a network region 2602 and a network region 2604, a global network 2606 and a multiplicity of servers with a sampling of servers denoted as a server device 2608 and a server device 2610.

Network region 2602 and network region 2604 may operate to represent a network contained within a geographical area or region. Non-limiting examples of representations for the geographical areas for the networked regions may include postal zip codes, telephone area codes, states, counties, cities and countries. Elements within network region 2602 and 2604 may operate to communicate with external elements within other networked regions or within elements contained within the same network region.

In some implementations, global network 2606 may operate as the Internet. It will be understood by those skilled in the art that communication system 2600 may take many different forms. Non-limiting examples of forms for communication system 2600 include local area networks (LANs), wide area networks (WANs), wired telephone networks, cellular telephone networks or any other network supporting data communication between respective entities via hardwired or wireless communication networks. Global network 2606 may operate to transfer information between the various networked elements.

Server device 2608 and server device 2610 may operate to execute software instructions, store information, support database operations and communicate with other networked elements. Non-limiting examples of software and scripting languages which may be executed on server device 2608 and server device 2610 include C, C++, C# and Java.

Network region 2602 may operate to communicate bi-directionally with global network 2606 via a communication channel 2612. Network region 2604 may operate to communicate bi-directionally with global network 2606 via a communication channel 2614. Server device 2608 may operate to communicate bi-directionally with global network 2606 via a communication channel 2616. Server device 2610 may operate to communicate bi-directionally with global network 2606 via a communication channel 2618. Network region 2602 and 2604, global network 2606 and server devices 2608 and 2610 may operate to communicate with each other and with every other networked device located within communication system 2600.

Server device 2608 includes a networking device 2620 and a server 2622. Networking device 2620 may operate to communicate bi-directionally with global network 2606 via communication channel 2616 and with server 2622 via a communication channel 2624. Server 2622 may operate to execute software instructions and store information.

Network region 2602 includes a multiplicity of clients with a sampling denoted as a client 2626 and a client 2628. Client 2626 includes a networking device 2634, a processor 2636, a GUI 2638 and an interface device 2640. Non-limiting examples of devices for GUI 2638 include monitors, televisions, cellular telephones, smartphones and PDAs (Personal Digital Assistants). Non-limiting examples of interface device 2640 include pointing device, mouse, trackball, scanner and printer. Networking device 2634 may communicate bi-directionally with global network 2606 via communication channel 2612 and with processor 2636 via a communication channel 2642. GUI 2638 may receive information from processor 2636 via a communication channel 2644 for presentation to a user for viewing. Interface device 2640 may operate to send control information to processor 2636 and to receive information from processor 2636 via a communication channel 2646. Network region 2604 includes a multiplicity of clients with a sampling denoted as a client 2630 and a client 2632. Client 2630 includes a networking device 2648, a processor 2650, a GUI 2652 and an interface device 2654. Non-limiting examples of devices for GUI 2638 include monitors, televisions, cellular telephones, smartphones and PDAs (Personal Digital Assistants). Non-limiting examples of interface device 2640 include pointing devices, mousse, trackballs, scanners and printers. Networking device 2648 may communicate bi-directionally with global network 2606 via communication channel 2614 and with processor 2650 via a communication channel 2656. GUI 2652 may receive information from processor 2650 via a communication channel 2658 for presentation to a user for viewing. Interface device 2654 may operate to send control information to processor 2650 and to receive information from processor 2650 via a communication channel 2660.

For example, consider the case where a user interfacing with client 2626 may want to execute a networked application. A user may enter the IP (Internet Protocol) address for the networked application using interface device 2640. The IP address information may be communicated to processor 2636 via communication channel 2646. Processor 2636 may then communicate the IP address information to networking device 2634 via communication channel 2642. Networking device 2634 may then communicate the IP address information to global network 2606 via communication channel 2612. Global network 2606 may then communicate the IP address information to networking device 2620 of server device 2608 via communication channel 2616. Networking device 2620 may then communicate the IP address information to server 2622 via communication channel 2624. Server 2622 may receive the IP address information and after processing the IP address information may communicate return information to networking device 2620 via communication channel 2624. Networking device 2620 may communicate the return information to global network 2606 via communication channel 2616. Global network 2606 may communicate the return information to networking device 2634 via communication channel 2612. Networking device 2634 may communicate the return information to processor 2636 via communication channel 2642. Processor 2636 may communicate the return information to GUI 2638 via communication channel 2644. User may then view the return information on GUI 2638.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6).

It is noted that according to USA law, all claims must be set forth as a coherent, cooperating set of limitations that work in functional combination to achieve a useful result as a whole. Accordingly, for any claim having functional limitations interpreted under 35 USC § 112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6) is/(are) dependent on one or more remote servers located outside the USA, it is intended that each such recited function under 35 USC § 112 (6) is to be interpreted as the function of the local system receiving the remotely generated information required by a locally implemented claim limitation, wherein the structures and or steps which enable, and breath life into the expression of such functions claimed under 35 USC § 112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC § 112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a system and method for providing number sense to a user according to the present invention will be apparent to those skilled in the art. Various aspects of the invention have been described above by way of illustration, and the specific embodiments disclosed are not intended to limit the invention to the particular forms disclosed. The particular implementation of the system and method for providing number sense to a user may vary depending upon the particular context or application. By way of example, and not limitation, the system and method for providing number sense to a user described in the foregoing were principally directed to providing number sense to a user for math problems; however, similar techniques may instead be applied to computer-implemented casino games such as blackjack, or computer-implemented lottery games, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A method comprising the steps of:
selecting by a user, a game using a designated software program loaded in a computer system;
selecting by a user, a difficulty level of the game for playing using the designated software program in the computer system;
selecting by a user, a game category within the selected difficulty level of the game for playing using the designated software program in the computer system;
transmitting game instruction, wherein the game instruction comprises number words that contain place values in tens and ones position for any period value ending in 11-99;
checking user input, by the designated software program;
determining if the user input is correct or incorrect;
transmitting and displaying a fail message if the user input is incorrect;
transmitting and displaying a reward message if the user input is correct; and
allowing the user to proceed to a new question in the game.

2. The method of claim 1, wherein the game instruction for the game category is provided at the top of a display screen of the computer system.

3. The method of claim 1, wherein the user is enabled to select an answer by using actions like tapping, dragging, etc. and moving the selected answer to an indicated location on a display screen of the computer system.

4. The method of claim 1, wherein the game category comprises an operator game, a sentence game, a matching game, an algebraic game, a visual object game, a dragging game, a grouping games, and the like.

5. The method of claim 4, wherein the operator game comprises a minimum of three value fields displaying numerals and equivalent number words that contain place values for any number that ends in 11-99 and/or contains a period value ending in 11-99, at least one operator sign selected from addition, subtraction, multiplication, division, or an equals, wherein the operator game comprises a question field and an answer field.

6. The method of claim 5, wherein one of the three value fields is an unknown value represented by a blank field in the question field, wherein at least two of the value fields occupy a position in the question field of the game, wherein at least one of the value fields occupy a position in the answer field of the game, and wherein when a user taps a correct answer the value field containing the correct answer appears on top of the blank field.

7. The method of claim 4, wherein the sentence game comprises at least one written statement for transmitting a game instruction in a question field, a minimum of three value fields displaying numerals and equivalent number words that contain place values for any number that ends in 11-99 and/or contains a period value ending in 11-99 in an answer field, wherein of the three value fields at least one value field displays a correct answer for the user to select, and the user has to select the response; wherein the written statement comprises descriptive words, symbols representational of a number of objects, images representational of a number of objects, or a combination thereof.

8. The method of claim 7, wherein either the written statement or the response comprise equivalent number word format that contains place values for any number that ends in 11-99 and/or contains a period value ending in 11-99.

9. The method of claim 4, wherein the algebraic game comprises a counting game, an equality-inequality game, and the like.

10. The method of claim 9, wherein the counting game comprises at least one count number displayed as number word format that contains place values for any number that ends in 11-99 and/or contains a period value ending in 11-99 and at least one object to be counted.

11. The method of claim 10, wherein the at least one count number may be displayed with or without a corresponding number word format that contains place values for any number that ends in 11-99 and/or contains a period value ending in 11-99, wherein a starting number is any integer, wherein a count increment is an integer or a decimal, wherein when a user selects a counting object, the count number counts by the count increment, and wherein the game is over when value of the count number reaches a specified target number, or when the user has tapped or dragged all count objects, etc., and wherein the count number or the counting object is placed in the question field or answer field.

12. The method of claim 9, wherein the equality-inequality game comprises at least two value fields, wherein each value field displays at least a numeral, at least an equivalent number word format that contains place values for any number that ends in 11-99 and/or contains a period value ending in 11-99, or a combination thereof, and a third field displaying an unknown sign selected from less than, greater than, or equal to; wherein the game comprises a question field and an answer field, wherein the at least two value fields are displayed in the question field along with a blank field in between, and the third field is displayed in the answer filed, wherein a user is enabled to move the correct answer from the answer field to the blank field in the question field by tapping or dragging the correct answer.

13. The method of claim 4, wherein the matching game comprises matching objects, numerals, or a combination thereof in a question field to corresponding number word format that contains place values in tens and ones position for any number that ends in 11-99 and/or contains a period value ending in 11-99 in an answer field, or matching statements or equations displaying corresponding number word format that contains place values for any number that ends in 11-99 and/or contains a period value ending in 11-99 in a question field to true-false statements in an answer field, etc.

14. The method of claim 4, wherein the visual object game comprises providing a user with an interface drawing representative of two sides of a field, wherein on one side is displayed a group of objects with or without corresponding number word format that contains place values for any number that ends in 11-99 and/or contains a period value ending in 11-99 and wherein on other side is displayed a numeral with or without corresponding number word format that contains place values for any number that ends in 11-99 and/or contains a period value ending in 11-99, or wherein on one side is displayed a group of objects and wherein on other side is displayed a corresponding number word format that contains place value for any number that ends in 11-99 and/or contains a period value ending in 11-99, and a combination thereof.

15. A method comprising:
steps for selecting by a user, a game using a designated software program loaded in a computer system;
steps for selecting by a user, a difficulty level of the game for playing using the designated software program in the computer system;
steps for selecting by a user, a game category within the selected difficulty level of the game for playing using the designated software program in the computer system;
steps for transmitting game instruction, wherein the game instruction comprises number words that contain place value for any number that ends in 11-99 and/or contains a period value ending in 11-99;
steps for checking user input, by the designated software program;
steps for determining if the user input is correct or incorrect;
steps for transmitting and displaying a fail message if the user input is incorrect
steps for transmitting and displaying a reward message if the user input is correct; and
steps for allowing the user to proceed to a new question in the game.

16. The method of claim 15, wherein the user is enabled to select an answer by using actions like tapping, dragging, etc. and moving the selected answer to an indicated location on a display screen of the computer system.

17. The method of claim 15, wherein the game category comprises an operator game, a sentence game, a matching game, an algebraic game, a visual object game, a dragging game, a grouping games, and the like.

18. A non-transitory computer-readable storage medium with an executable program stored thereon, wherein the program instructs one or more processors to perform the following steps:
selecting by a user, a game using a designated software program loaded in a computer system;
selecting by a user, a difficulty level of the game for playing using the designated software program in the computer system;
selecting by a user, a game category within the selected difficulty level of the game for playing using the designated software program in the computer system;
transmitting game instruction, wherein the game instruction comprises number words that contain place values for any number that ends in 11-99 and/or contains a period value ending in 11-99;
checking user input, by the designated software program;
determining if the user input is correct or incorrect;
transmitting and displaying a fail message if the user input is incorrect;
transmitting and displaying a reward message if the user input is correct; and
allowing the user to proceed to a new question in the game.

19. The program of claim 18, wherein the game category comprises an operator game, a sentence game, a matching game, an algebraic game, a visual object game, a dragging game, a grouping games, and the like.

20. The program of claim 18, wherein the computer system comprises a touch screen device, a mouse-equipped device, a keyboard device, a joystick selector, a track pad and/or buttons as part of a console device that work with a remote monitor or television or has its own display screen, a television remote, a virtual reality headset or VR glasses, with or without VR gloves or hand input, a microphone input wherein a user may select answer by speaking the selected answer into a microphone, a selection tool for differently abled learners, and the like and a combination thereof.
